(19) United States
(12) Patent Application Publication
(10) Pub. No.: US 2008/0284798 A1
(43) Pub. Date: Nov. 20, 2008

(54) POST-RENDER GRAPHICS OVERLAYS

(75) Inventors: Steven Todd Weybrew, Portland, OR (US); Brian Ellis, San Diego, CA (US); Baback Elmieh, Carlsbad, CA (US); Simon Wilson, Dacono, CO (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/116,056

(22) Filed: May 6, 2008

Related U.S. Application Data
(60) Provisional application No. 60/916,303, filed on May 7, 2007.

(51) Int. Cl. G09G 5/00

(52) U.S. Cl. 345/630; 345/629

(57) ABSTRACT

In general, the present disclosure describes various techniques for overlaying or combining a set of rendered graphics surfaces onto a single graphics frame. One example device includes a first processor that selects a surface level for each of a plurality of rendered graphics surfaces prior to the device outputting any of the rendered graphics surfaces to a display. The device further includes a second processor that retrieves the rendered graphics surfaces, overlays the rendered graphics surfaces onto a graphics frame in accordance with each of the selected surface levels, and outputs the graphics frame to the display.

### RELATED APPLICATION

This application claims the benefit of U.S. Provisional Application No. 60/916,303, filed on May 7, 2007, the entire contents of which is incorporated herein by reference.

### TECHNICAL FIELD

This disclosure relates to graphics processing, and more particularly, relates to the overlay of graphics surfaces after a rendering process.

### BACKGROUND

Graphics processors are widely used to render two-dimensional (2D) and three-dimensional (3D) images for various applications, such as video games, graphics programs, computer-aided design (CAD) applications, simulation and visualization tools, and imaging. Display processors may then be used to display the rendered output.

Graphics processors, display processors, or multi-media processors used in these applications may be configured to perform parallel and/or vector processing of data. General purpose CPU's (central processing units) with or without SIMD (single instruction, multiple data) extensions may also be configured to process data. In SIMD vector processing, a single instruction operates on multiple data items at the same time.

OpenGL® (Open Graphics Library) is a standard specification defining a cross-platform API (Application Programming Interface) that may be used when writing applications that produce 2D and 3D graphics. Other languages, such as Java, may define bindings to the OpenGL API's through their own standard processes. The API includes multiple functions that, when implemented in a graphics application, can be used to draw scenes from simple primitives. Graphics processors, multi-media processors, and even general purpose CPU's can execute applications that are written using OpenGL function calls. OpenGL ES (embedded systems) is a variant of OpenGL that is designed for embedded devices, such as mobile phones, PDA's, or video game consoles. OpenVG™ (Open Vector Graphics) is another standard API that is primarily designed for hardware-accelerated 2D vector graphics.

EGL™ (Embedded Graphics Library) is a platform interface layer between rendering API's (such as OpenGL ES, OpenVG, and several other standard multi-media API's) and the underlying platform multi-media facilities. EGL can handle graphics context management, rendering surface creation, and rendering synchronization and enables high-performance, hardware accelerated, and mixed-mode 2D and 3D rendering.

For rendering surface creation, EGL provides mechanisms for creating both on-screen surfaces (e.g., window surfaces) and off-screen surfaces (e.g., pbuffers, pixmaps) onto which client API's can draw and which client API's can share. On-screen surfaces are typically rendered directly into an active window's frame buffer memory. Off-screen surfaces are typically rendered into off-screen buffers for later use. Pbuffers are off-screen memory buffers that may be stored, for example, in memory space associated with OpenGL server-side (driver) operations. Pixmaps are off-screen memory areas that are commonly stored, for example, in memory space associated with a client application.

### SUMMARY

In general, the present disclosure describes various techniques for overlaying or combining a set of rendered or pre-rendered graphics surfaces onto a single graphics frame. In one aspect, a device includes a first processor that selects a surface level for each of a plurality of rendered graphics surfaces prior to the device outputting any of the rendered graphics surfaces to a display. The device further includes a second processor that retrieves the rendered graphics surfaces, overlays the rendered graphics surfaces onto a graphics frame in accordance with each of the selected surface levels, and outputs the resultant graphics frame to the display.

In another aspect a method includes retrieving a plurality of rendered graphics surfaces. The method further includes selecting a surface level for each of the rendered graphics surfaces prior to outputting any of the rendered graphics surfaces to a display. The method further includes overlaying the rendered graphics surfaces onto a graphics frame in accordance with each of the selected surface levels. The method further includes outputting the resultant graphics frame to the display.

In an additional aspect, a computer-readable medium includes instructions for causing one or more programmable processors to retrieve a plurality of rendered graphics surfaces, select a surface level for each of the rendered graphics surfaces prior to outputting any of the rendered graphics surfaces to a display, overlay the rendered graphics surfaces onto a graphics frame in accordance with each of the selected surface levels, and output the resultant graphics frame to the display. The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example device that may be used to overlay a set of rendered or pre-rendered graphics surfaces onto a graphics frame.

FIG. 2 is a block diagram illustrating an example surface profile for a rendered surface stored within the device of FIG. 1.

FIG. 3A is a block diagram illustrating an example overlay stack that may be used within the device of FIG. 1.

FIG. 3B is a block diagram illustrating another example overlay stack that may be used within the device of FIG. 1.

FIG. 3C is a block diagram illustrating an example layer that may be used in the overlay stack of FIG. 3B.

FIG. 4A is a conceptual diagram depicting an overlay stack and the relationship between overlay layers, underlay layers, and a base layer.

FIG. 4B illustrates an example layer used in the overlay stack of FIG. 4A in greater detail.

FIG. 5A is a block diagram illustrating further details of the API libraries shown in FIG. 1.

FIG. 5B is a block diagram illustrating further details of the drivers shown in FIG. 1.

FIG. 6 is a block diagram illustrating another example device that may be used to overlay or combine a set of rendered graphics surfaces onto a graphics frame.

FIG. 7 is a block diagram illustrating an example device having both a 2D graphics processor and a 3D graphics processor that may be used to overlay or combine a set of rendered graphics surfaces onto a graphics frame.

FIG. 8 is a flowchart of a method for overlaying or combining rendered graphics surfaces.

FIG. 9 is a flowchart of another method for overlaying or combining rendered graphics surfaces.

### DETAILED DESCRIPTION

In general, the present disclosure describes various techniques for overlaying or combining a set of rendered or pre-rendered graphics surfaces onto a single graphics frame. The graphics surfaces may be two-dimensional (2D) surfaces, three-dimensional (3D) surfaces, and/or video surfaces. A 2D surface may be generated by software or hardware that implements functions of a 2D API, such as OpenVG. A 3D surface may be generated by software or hardware that implements functions of a 3D API, such as OpenGL ES. A video surface may be generated by a video decoder, such as, for example, an ITU H.264 or MPEG4 (Moving Picture Experts Group version 4) compliant video decoder. The rendered graphics surfaces may be on-screen surfaces, such as window surfaces, or off-screen surfaces, such as pbuffer surfaces or pixmap surfaces. Each of these surfaces can be displayed as a still image or as part of a set of moving images, such as video or synthetic animation. In this disclosure, a pre-rendered graphics surface may refer to (1) content that is rendered and saved to an image file by an application program, and which may be subsequently loaded from the image file by a graphics application with or without further processing; or (2) images that are rendered by a graphics application as part of the initialization process of the graphics application, but not during the primary animation runtime loop of the graphics application. In addition, a rendered graphics surface may refer to a pre-rendered graphics surface or to any sort of data structure that defines or includes rendered data. In one aspect, each graphics surface may have a surface level associated with the surface. The surface level determines the level at which each graphics surface is overlaid onto a graphics frame. The surface level may, in some cases, be defined as any number, wherein the higher the number, the higher on the displayed graphics frame the surface will be displayed. In other words, surfaces having higher surface levels may appear closer to the viewer of a display. That is, objects contained in surfaces that have higher surface levels may appear in front of other objects contained in surfaces that have lower surface levels. As a simple example, the background image, or “wallpaper”, used on a desktop computer would have a lower surface level than the icons on the desktop. In one aspect, a display processor may combine the graphics surfaces according to one or more compositing or blending modes. Examples of such compositing modes include (1) overwriting, (2) alpha blending, (3) color-keying without alpha blending, and (4) color-keying with alpha blending. According to the overwriting compositing mode, where portions of two surfaces overlap, the overlapping portions of a surface with a higher surface level may be displayed instead of the overlapping portions of any surface with a lower surface level.

In some cases, a display processor may combine the surfaces in accordance with an overlay stack that defines a plurality of layers with each layer corresponding to a different layer level. Each layer may include one or more surfaces that are bound to the layer. A display processor may then traverse the overlay stack to determine the order in which the surfaces are to be combined. In one aspect, a user program or API function may selectively enable or disable individual surfaces within the overlay stack, and then the display processor combines only those surfaces which have been enabled. In another aspect, a user program or API function may selectively enable or disable entire layers within the overlay stack, and then the display processor combines only those enabled surfaces which are bound to enabled layers.

In graphics intensive applications, such as video games, many of the graphics surfaces to be overlaid are 2D surfaces that are generated by software and hardware implementations of 2D APIs, and are not generated by 3D hardware. Many of the standards for rendering 3D graphics, however, do not include specifications for overlaying such 2D graphics surfaces onto 3D graphics surfaces. As such, complicated rendering engines capable of synchronizing the rendering of 2D and 3D surfaces are sometimes employed for such applications, but the complexity of such rendering engines can adversely affect overall system cost, graphics performance, and power consumption of such systems.

The overlay and compositing techniques in this disclosure may provide one or more advantages. For example, a video game may display complex 3D graphics as well as simple graphical objects, such as 2D graphics and relatively static objects. These simple graphical objects can be rendered as off-screen surfaces separate from the complex 3D graphics. The rendered off-screen surfaces can be overlayed (i.e. combined) with the complex 3D graphics surfaces to generate a final graphics frame. Because the simple graphical objects may not require 3D graphics rendering capabilities, such objects can be rendered using techniques that consume less hardware resources in a graphics processing system. For example, such objects may be rendered by a processor that uses a general purpose processing pipeline or rendered by a processor having 2D graphics acceleration capabilities. In addition, such objects may be pre-rendered and stored for later use within the graphics processing system. By rendering or pre-rendering the simple graphical objects separate from the complex 3D graphics, the load on the 3D graphics rendering hardware can be reduced. This is especially important in the world of mobile communications, where a reduced load on 3D graphics hardware can result in a power savings for the mobile device and/or increased overall performance, i.e. higher sustained framerate.

In addition, by dividing up graphics processing into a graphics processor that performs complex rendering and a display processor that combines on-screen and off-screen surfaces, and by operating these two processors in parallel, the clock rate of the graphics processor can be reduced. Moreover, because power consumption increases nonlinearly with the clock rate of the graphics processor, additional power savings can be achieved in the graphics processing system.

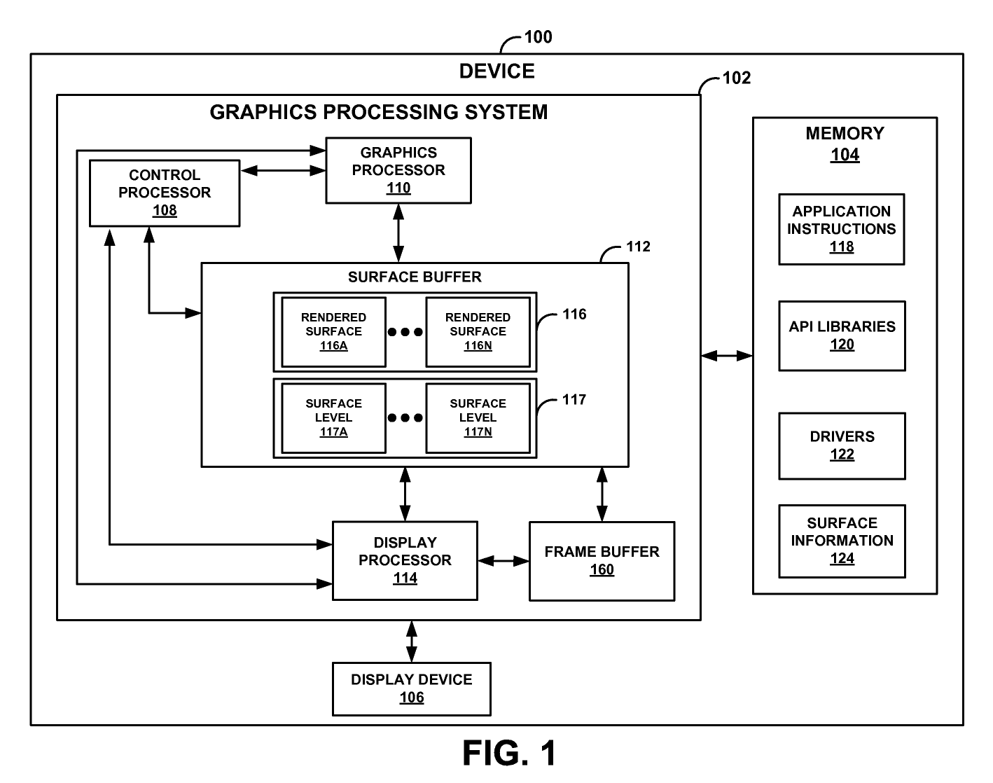

FIG. 1 is a block diagram illustrating a device 100 that may be used to overlay or combine a set of rendered graphics surfaces onto a graphics frame, according to an aspect of the disclosure. Device 100 may be a stand-alone device or may be part of a larger system. For example, device 100 may comprise a wireless communication device (such as a wireless handset), or may be part of a digital camera, digital multimedia player, personal digital assistant (PDA), video game console, mobile gaming device, or other video device. In one aspect, device 100 may comprise or be part of a personal computer (PC) or laptop device. Device 100 may also be included in one or more integrated circuits, or chips.

Device 100 may be capable of executing various different applications, such as graphics applications, video applications, or other multi-media applications. For example, device 100 may be used for graphics applications, video game applications, video applications, applications which combine video and graphics, digital camera applications, instant messaging applications, mobile applications, video telephony, or video streaming applications.

Device 100 may be capable of processing a variety of different data types and formats. For example, device 100 may process still image data, moving image (video) data, or other multi-media data, as will be described in more detail below. In the example of FIG. 1, device 100 includes a graphics processing system 102, memory 104, and a display device 106. Programmable processors 108, 110, and 114 may be included within graphics processing system 102. Programmable processor 108 may be a control, or general-purpose, processor, and may comprise a system CPU (central processing unit). Programmable processor 110 may be a graphics processor, and programmable processor 114 may be a display processor. Control processor 108 may be capable of controlling both graphics processor 110 and display processor 114. Processors 108, 110, and 114 may be scalar or vector processors. In one aspect, device 100 may include other forms of multi-media processors.

In one aspect, graphics processing system 102 may be implemented on several different subsystems or components that are physically separate from each other. In such a case, one or more of programmable processors 108, 110, 114 may be implemented on different components. For example, one implementation of graphics processing system 102 may include control processor 108 and display processor 114 on a first component or subsystem, and graphics processor 110 on a second component or subsystem.

In device 100, graphics processing system 102 may be coupled both to a memory 104 and to a display device 106. Memory 104 may include any permanent or volatile memory that is capable of storing instructions and/or data. Display device 106 may be any device capable of displaying 3D image data, 2D image data, or video data for display purposes, such as an LCD (liquid crystal display) or a standard television display device.

Graphics processor 110 may be a dedicated graphics rendering device utilized to render, manipulate, and display computerized graphics. Graphics processor 110 may implement various complex graphics-related algorithms. For example, the complex algorithms may correspond to representations of two-dimensional or three-dimensional computerized graphics. Graphics processor 110 may implement a number of so-called “primitive” graphics operations, such as forming points, lines, triangles, or other polygons, to create complex, three-dimensional images for presentation on a display, such as display device 106.

In this disclosure, the term “render” may refer to 3D and/or 2D rendering. As examples, graphics processor 110 may utilize OpenGL instructions to render 3D graphics surfaces, or may utilize OpenVG instructions to render 2D graphics surfaces. However, in various aspects, any standards, methods, or techniques for rendering graphics may be utilized by graphics processor 110. In one aspect, control processor 108 may also utilize OpenVG instructions to render 2D graphics surfaces.

Graphics processor 110 may carry out instructions that are stored in memory 104. Memory 104 is capable of storing application instructions 118 for an application (such as a graphics or video application), API libraries 120, drivers 122, and surface information 124. Application instructions 118 may be loaded from memory 104 into graphics processing system 102 for execution. For example, one or more of control processor 108, graphics processor 110, and display processor 114 may execute one or more of instructions 118.

Control processor 108, graphics processor 110, and/or display processor 114 may also load and execute instructions contained within API libraries 120 or drivers 122 during execution of application instructions 118. Instructions 118 may refer to or otherwise invoke certain functions within API libraries 120 or drivers 122. Thus, when graphics processing system 102 executes instructions 118, it may also execute identified instructions within API libraries 120 and/or drivers 122, as will be described in more detail below. Drivers 122 may include functionality that is specific to one or more of control processor 108, graphics processor 110, and display processor 114. In one aspect, application instructions 118, API libraries 120, and/or drivers 122 may be loaded into memory 104 from a storage device, such as a non-volatile data storage medium. Graphics processing system 102 also includes surface buffer 112. Graphics processor 110, control processor 108, and display processor 114 each may be operatively coupled to surface buffer 112, such that each of these processors may either read data out of or write data into surface buffer 112. Surface buffer 112 also may be operatively coupled to frame buffer 160. Although shown as included within graphics processing system 102 in FIG. 1, surface buffer 112 and frame buffer 160 may also, in some aspects, be included directly within memory 104.

Surface buffer 112 may be any permanent or volatile memory capable of storing data, such as, for example, synchronous dynamic random access memory (SDRAM), embedded dynamic random access memory (eDRAM), or static random access memory (SRAM). When graphics processor 110 renders a graphics surface, such as an on-screen surface or an off-screen surface, graphics processor 110 may store such rendering data in surface buffer 112. Each graphics surface rendered may be defined by its size and shape. The size and shape may not be confined by the actual physical size of the display device 106 being used, as post-render scaling and rotation functions may be applied to the rendered surface by display processor 114.

Surface buffer 112 may include one or more rendered graphics surfaces 116A-116N (collectively, 116), and one or more surface levels 117A-117N (collectively, 117). Each rendered surface in 116 may contain rendered surface data that includes size data, shape data, pixel color data and other rendering data that may be generated during surface rendering. Each rendered surface in 116 may also have a surface level 117 that is associated with the rendered surface 116. Each surface level 117 defines the level at which the corresponding rendered surface in 116 is overlaid or underlaid onto the resulting graphics frame. Although surface buffer 112 is shown in FIG. 1 as a single surface buffer, surface buffer 112 may comprise one or more surface buffers each storing one or more rendered surfaces 116A-116N.

A rendered surface, such as surface 116A, may be an on-screen surface, such as a window surface, or an off-screen surface, such as a pbuffer surface or a pixmap surface. The window surfaces and pixmap surfaces may be tied to corresponding windows and pixmaps within the native windowing system. Pixmaps may be used for off screen rendering into buffers that can be accessed through native APIs. In one aspect, a client application may generate initial surfaces by calling functions associated with a platform interface layer, such as an instantiation of the EGL API. After the initial surfaces are created, the client application may associate a rendering context (i.e., state machine) with each initial surface. The rendering context may be generated by an instantiation of a cross-platform API, such as OpenGL ES. Then, the client application can render data into the initial surface to generate a rendered surface. The client application may render data into the initial surface by causing a programmable processor, such as control processor 108 or graphics processor 110, to generate a rendered surface.

Rendered surfaces 116 may originate from several different sources within device 100. For example, graphics processor 110 and control processor 108 may each generate one or more rendered surfaces, and then store the rendered surfaces in surface buffer 112. Graphics processor 110 may generate the rendered surfaces by using an accelerated 3D graphics rendering pipeline in response to instructions received from control processor 108. Control processor 108 may generate the rendered surfaces by using a general purpose processing pipeline, which is not accelerated for graphics rendering. Control processor 108 may also retrieve rendered surfaces stored within various portions of memory 104, such as rendered or pre-rendered surfaces stored within surface information 124 of memory 104. Thus, each of rendered surfaces 116A-116N may originate from the same or different sources within device 100.

In one aspect, the rendered surfaces generated by graphics processor 110 may be on-screen surfaces, and the rendered surfaces generated or retrieved by control processor 108 may be off-screen surfaces. In another aspect, graphics processor 110 may generate both on-screen surfaces as well as off-screen surfaces. The off-screen surfaces generated by graphics processor 110 may be generated at designated times when graphics processor 110 is under-utilized (i.e., has a relatively large amount of available resources), and then stored in surface buffer 112. Display processor 114 may then overlay the pre-generated graphics surfaces onto a graphics frame at a time when graphics processor 110 may be over-utilized (i.e., has a relatively small amount of available resources). By pre-rendering certain graphics surfaces within device 100, the average throughput of graphics processor 110 may be improved, which can result in overall power savings to graphics processing system 102.

Display processor 114 is capable of retrieving rendered surfaces 116 from surface buffer 112, overlaying the rendered graphics surfaces onto a graphics frame, and driving display device 106 to display the resultant graphics frame. The level at which each graphics surface 116 is overlaid may be determined by a corresponding surface level 117 defined for the graphics surface. Surface levels 117A-117N may be defined by a user program, such as by application instructions 118, and stored as a parameter associated with a rendered surface. The surface level may be stored in surface buffer 112 or in the surface information 124 block of memory 104.

Surface levels 117A-117N may each be defined as any number, wherein the higher the number the higher on the displayed graphics frame the surface will be displayed. For example, surfaces having higher surface levels may appear closer to the viewer of a display. That is, objects contained in surfaces that have higher surface levels may appear in front of objects contained in surfaces that have lower surface levels.

In one aspect, display processor 114 may combine the graphics surfaces according to one or more compositing or blending modes, such as, for example: (1) overwriting, (2) alpha blending, (3) color-keying without alpha blending, and (4) color-keying with alpha blending. According to the overwriting compositing mode, where portions of two surfaces overlap, the overlapping portions of a surface with a higher surface level may be displayed instead of the overlapping portions of any surface with a lower surface level. As a simple example, the background image used on a desktop computer would have a lower surface level than the icons on the desktop. In some cases, display processor 114 may use orthographic projections or other perspective projections to combine the rendered graphics surfaces. The alpha blending compositing mode may perform alpha blending according to, for example, a full surface constant alpha blending algorithm, or according a full surface per-pixel alpha blending algorithm.

According to the color-keying with alpha blending compositing mode, when two surfaces overlap, display processor 114 determines which surface has a higher surface level and which surface has a lower surface level. Display processor 114 may then check each pixel within the overlapping portion of the higher surface to determine which pixels match the key color (e.g. magenta). For any pixels that match the key color, the corresponding pixel from the lower surface (i.e., the pixel having the same display location) will be chosen as the output pixel (i.e., displayed pixel). For any pixels that do not match the key color, the pixel of the higher surface, along with the corresponding pixel from the lower surface, will be blended together according to an alpha blending algorithm to generate the output pixel.

When the selected compositing mode is color-keying without alpha blending, display processor 114 may check each pixel within the overlapping portion of the higher surface to determine which pixels match the key color. For any pixels that match the key color, the corresponding pixel from the lower surface (i.e., the pixel having the same display location) will be chosen as the output pixel. For any pixels that do not match the key color, the pixel from the higher surface is chosen as the output pixel.

In any case, display processor 114 combines the layers according to the selected compositing mode to generate a resulting graphics frame that may be loaded into frame buffer 160. Display processor 114 may also perform other post-rendering functions on a rendered graphics surface or frame, including scaling and rotation. The scaling and rotation functions may be specified in one or more EGL extensions.

In some aspects, control processor 108 may be a RISC processor, such as the ARM₁₁ processor embedded in Mobile Station Modems designed by Qualcomm, Inc. of San Diego, Calif. In some aspects, display processor 114 may be a mobile display processor (MDP) also embedded in Mobile Station Modems designed by Qualcomm, Inc. Any of processors 108, 110, and 114 are capable of accessing rendered surfaces 116A-116N within buffer space 112. In one aspect, each processor 108, 110, and 114 may be capable of providing rendering capabilities and writing rendered output data for graphics surfaces into surface buffer 112.

Memory 104 also includes surface information 124 that stores information relating to rendered graphics surfaces that are created within graphics processing system 102. For example, surface information 124 may include surface profiles. The surface profiles may include rendered surface data, surface level data, and other parameters that are specific to each surface. Surface information 124 may also include information relating to composite surfaces, overlay stacks, and layers. The overlay stacks may store information relating to how surfaces bound to the overlay stack should be combined into the resulting graphics frame. For example, an overlay stack may store a sequence of layers to be overlaid and underlaid with respect to a window surface. Each layer may have one or more surfaces that are bound to the layer. Surface information 124 may be loaded into surface buffer 112 of graphics processing system 102 or other buffers (not shown) for use by programmable processors 108, 110, 114. Updated information within surface buffer 112 may also be provided back for storage within surface information 124 of memory 104.

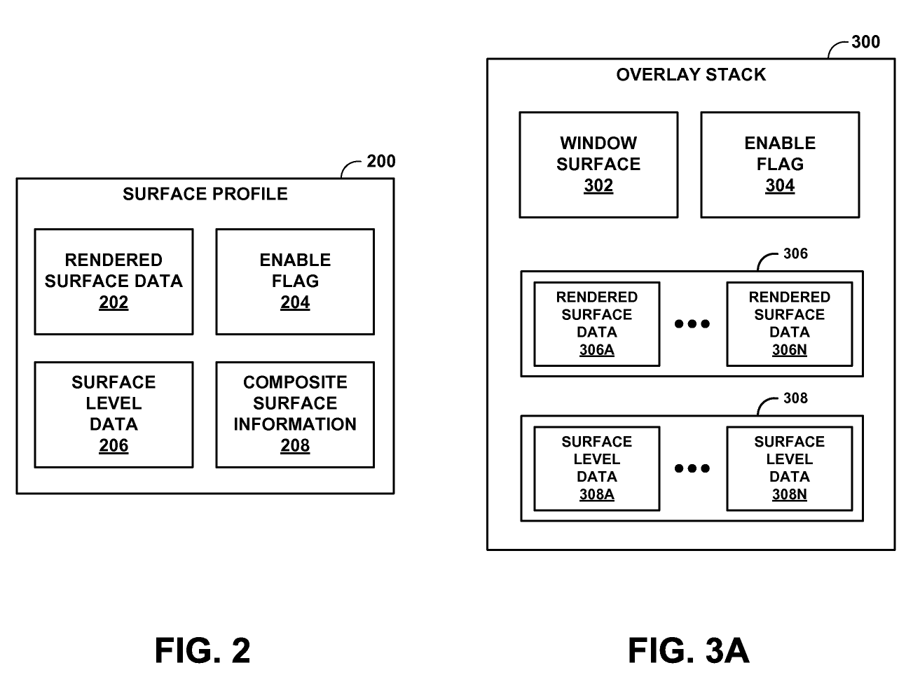

FIG. 2 is a block diagram illustrating an example surface profile 200 for a rendered surface stored within device 100. Surface profile 200 may be generated by one of programmable processors 108, 110, 114 as well as by a user program contained in application instructions 118 or by API functions contained in API libraries 120. Once created, surface profile 200 may be stored in surface information block 124 of memory 104, surface buffer 112, or within other buffers (not shown) within graphics processing system 102. Surface profile 200 may include rendered surface data 202, enable flag 204, surface level data 206, and composite surface information 208. Rendered surface data 202 may include size data, shape data, pixel color data, and/or other rendering data that may be generated during surface rendering.

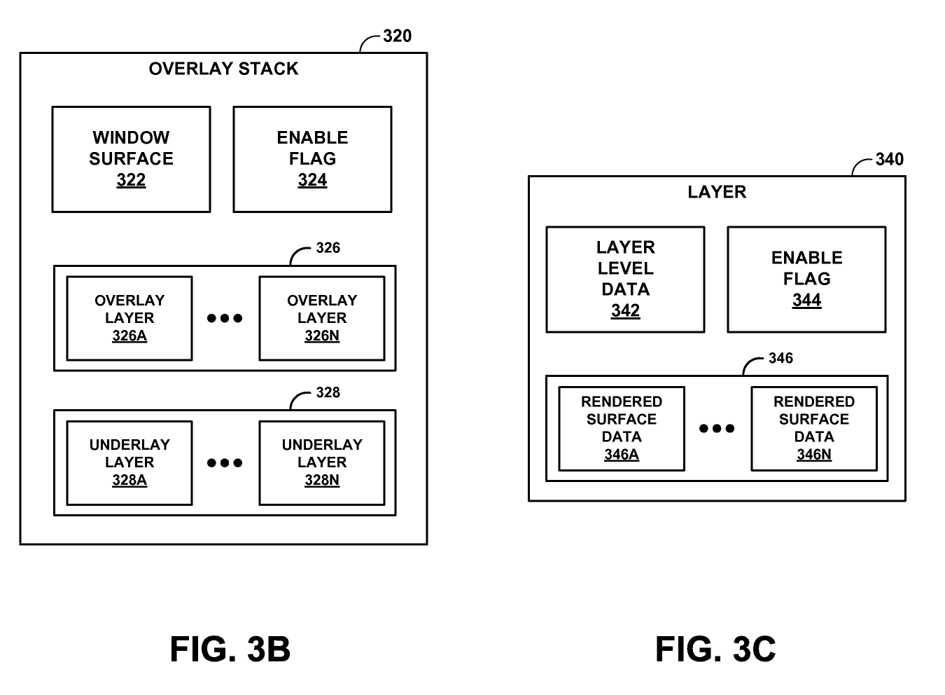

Enable flag 204 indicates whether the surface corresponding to the surface profile is enabled or disabled. In one aspect, if the enable flag 204 for a surface is set, the surface is enabled, and display processor 114 will overlay the surface onto the resulting graphics frame. Otherwise, if enable flag 204 is not set, the surface is disabled, and display processor 114 will not overlay the surface onto the resulting graphics frame. In another aspect, if enable flag 204 for a surface is set, display processor 114 may overlay the surface onto the resulting graphics frame only if the overlay stack enable flag (FIG. 3A-304) is also set for the overlay stack to which the surface is bound. Otherwise, if either the overlay stack enable flag or surface enable flag 204 are not set, display processor will not overlay the surface onto the resulting graphics frame. In another aspect, if enable flag 204 for a surface is set, display processor 114 may overlay the surface onto the resulting graphics frame only if both the overlay stack enable flag (FIG. 3B-324) and the layer enable flag (FIG. 3C-344) are set for the overlay stack and layer to which the surface is bound. Otherwise, if any of the enable flags are not set, display processor 114 will not overlay the surface onto the resulting graphics frame.

Surface level data 206 determines the level at which each graphics surface 116 is overlaid by display processor 114 onto the resulting graphics frame. Surface level data 206 may be defined by a user program, such as by application instructions 118. Composite surface information 208 may store information identifying the composite surface or overlay stack associated with a particular surface profile.

In one aspect, programmable processors 108, 110, 114 may upload various portions of the surface profiles stored in memory 104 into surface buffer 112. For example, control processor 108, may upload rendered surface data 202 and surface level data 206 from surface profile 200, and store the uploaded data in surface buffer 112.

FIG. 3A is a block diagram illustrating an example overlay stack 300 that may be associated with a composite surface, according to one aspect. Overlay stack 300 may be generated by one of programmable processors 108, 110, 114 as well as by a user program contained in application instructions 118 or by API functions contained in API libraries 120. Once created, overlay stack may be stored in surface information block 124 of memory 104, surface buffer 112, or within other buffers (not shown) within graphics processing system 102.

Overlay stack 300 includes window surface 302, enable flag 304, rendered surface data 306A-306N (collectively, 306), and surface level data 308A-308N (collectively, 308). Window surface 302 may be an on-screen rendering surface that is associated with a base layer (e.g., layer zero) in the overlay stack. Window surface 302 may be the same size and shape as the resulting graphics frame stored in frame buffer 160 and subsequently displayed on display device 106. Rendered surface data 306 and surface level data 308 may correspond to rendered surface data and surface level data stored in the surface information block 124 of memory 104 and/or within surface buffer 112 of graphics processing system 102. In some cases, overlay stack 300 may include entire surface profiles 200 for a rendered surface, while in other cases overlay stack 300 may contain address pointers that point to other data structures that contain surface information for processing by overlay stack 300.

In one aspect, window surface 302 may be assigned a surface level of zero defined as the base surface level. Surfaces having positive surfaces levels may overlay window surface 302, and are referred to herein as overlay surfaces. Surfaces having negative surface levels underlay window surface 302 and are referred to herein as underlay surfaces. Overlay surfaces may have positive surface levels, wherein the more positive the surface level is, the closer the surface appears to the viewer of display device 106. For example, objects contained in layers that have higher layer levels may appear in front of objects contained in layers that have lower layer levels. Likewise, underlay surfaces may have negative surface levels, wherein the more negative the surface level is, the farther away the surface appears to the viewer of display device 106. For example, objects contained in layers that have lower layer levels may appear behind or in back of objects contained in layers that have higher layer levels. In some cases, overlay stack 300 may be required to have at least one overlay surface or one underlay surface. A user application may query overlay stack 300 to determine how many layers are supported and how many surfaces are currently bound to each layer. Overlay stack 300 may also have a composite surface associated with the stack. The composite surface may be read-only from the user program's perspective and used by other APIs or display processor 114 as a compositing buffer if necessary. Alternatively, the overlay stack may be composited “on-the-fly” as the data is sent to display device 106 without using a dedicated compositing buffer or surface.

Enable flag 304 determines whether overlay stack 300 is enabled or disabled. If enable flag 304 is set for overlay stack 300, the overlay stack is enabled, and display processor 114 may combine or process all enabled surfaces within overlay stack 300 into the resulting graphics frame. Otherwise, if enable flag 304 is not set, overlay stack 304 is disabled, and display processor 114 may not use the overlay stack or process any associated surface elements when generating the resulting graphics frame. According to one aspect, when overlay stack 300 is disabled, window surface 302 may still be enabled and all other overlay and underlay surfaces may be disabled. Thus, window surface 302 may not be disabled according to this aspect. In other aspects, the entire overlay stack may be disabled including window surface 302.

When combining the surfaces, display processor 114 may refer to overlay stack 300 to determine the order in which to overlay, underlay, or otherwise combine rendered surfaces 306. In one example, display processor 114 may identify a first surface that appears farthest away from a viewer of the display by finding a surface in overlay stack 300 having a lowest surface level. Then, display processor 114 may identify a second surface in overlay stack 300 that has a second lowest surface level that is greater than the surface level of the first surface. Display processor 114 may then combine the first and second surfaces according to a compositing mode. Display processor 114 may continue to overlay surfaces from back to front ending with a surface that has a highest surface level, and which appears closest to the viewer. In this manner, display processor 114 may traverse overlay stack 306 to sequentially combine rendered surfaces 306 and generate a resulting graphics frame.

In some cases, display processor 114 may check each surface to see whether an enable flag 204 has been set for the surface. If the enable flag is set (i.e., the surface is enabled), display processor 114 may combine or process the surface with the other enabled surfaces in overlay stack 300. If the enable flag is not set (i.e., the surface is disabled), display processor 114 may not combine or process the surface with other surfaces in overlay stack 300. The enable flags of surfaces stored within overlay stack 300 may be set or reset by a user program or API instruction executing on one of programmable processors 108, 110, 114. In this manner, a user program may selectively enable and disable surfaces for any particular graphics frame.

FIG. 3B is a block diagram illustrating an example overlay stack 320 that may be associated with a composite surface, according to another aspect. Similar to overlay stack 300, overlay stack 320 may also be generated by one of programmable processors 108, 110, 114, as well as by a user program contained in application instructions 118 or by API functions contained in API libraries 120. Once created, overlay stack may be stored in surface information block 124 of memory 104, surface buffer 112, or within other buffers (not shown) within graphics processing system 102. Overlay stack 320 includes window surface 322, enable flag 324, rendered overlay layers 326A-326N (collectively, 326), and underlay layers 328A-328N (collectively, 328). Window surface 322 may be an on-screen rendering surface that is associated with a base layer (e.g., layer 0) in the overlay stack. Window surface 322 may be the same size and shape as the resulting graphics frame stored in frame buffer 160 and subsequently displayed on display device 106.

Window surface 322 may be assigned a layer level of zero (base layer). Layers having positive layer levels may overlay window surface 322, and are referred to herein as overlay layers. Layers having negative layer levels underlay window surface 322 and are referred to herein as underlay layers. Overlay layers may have positive layer levels, wherein the more positive the layer level is, the closer the layer appears to the viewer of display device 106. Likewise, underlay layers may have negative layer levels, wherein the more negative the layer level is, the farther away the layer appears to the viewer of display device 106. Each layer may have multiple surfaces that are bound to the layer by a user program or API instruction executing one of programmable processors 108, 110, 114. In some cases, layer zero (i.e. the base layer) may be restricted to a single rendered surface, namely, window surface 322. In additional cases, overlay stack 320 may have at least one overlay layer or one underlay layer. A user application may query overlay stack 320 to determine how many layers are supported and how many surfaces may be bound to each layer. Overlay stack 320 may have a composite surface associated with the overlay stack. The composite surface may be read-only from the user program's perspective and used by other APIs or display processor 114 as a compositing buffer if necessary. Alternatively, the overlay stack may be composited “on-the-fly” as the data is sent to display device 106 without using a dedicated compositing buffer.

Enable flag 324 determines whether overlay stack 320 is enabled or disabled. If enable flag 324 is set for overlay stack 320, then overlay stack 320 is enabled, and display processor 114 may combine or process all enabled layers within overlay stack 320 into a resulting graphics frame. Otherwise, if enable flag 324 is not set, overlay stack 320 is disabled, and display processor 114 may not use the overlay stack 320 or process any associated surface elements when generating the resulting graphics frame. According to one aspect, when overlay stack 320 is disabled, window surface 322 may still be enabled, and overlay layers 326 and underlay layers 328 may be disabled. Thus, window surface 322 may not be disabled according to this aspect. In other aspects, the entire overlay stack may be disabled including window surface 322.

When combining the layers, display processor 114 may refer to overlay stack 320 to determine the order in which to overlay, underlay, or otherwise combine the layers. In one example, display processor 114 may identify a first layer that that appears farthest away from a viewer of the display by finding a surface in the overlay stack 320 that has a lowest surface level. Then, display processor 114 may identify all rendered surfaces that are bound to the first layer. Display processor 114 may then combine the rendered surfaces of the first layer using a compositing algorithm, possibly applying one or more of a variety of pixel blending and keying operations according to a selected compositing mode. In some cases, display processor 114 may check to see if each surface in the first layer is enabled, and then combine only the enabled surfaces within the first layer. Display processor 114 may use a composite surface to temporarily store the combined surfaces of the first layer. Then, display processor 114, identifies a second surface in overlay stack 320 that has a second lowest layer level. The second lowest layer level may be the lowest layer level that is still greater than the layer level of the first layer. Display processor 114 may then combine the rendered surfaces bound to the second layer with the composite surface previously generated. If two surfaces bound to the same layer are overlapping, display processor 114 may combine the surfaces according to the order in which the surfaces were bound to the layer as described in further detail below. Display processor 114 may continue to combine layers from back to front ending with a layer that has a highest layer level, and which appears closest to the viewer. In this manner, display processor 114 may traverse overlay stack 320 to sequentially combine layers and generate a resulting graphics frame.

In some cases, display processor 114 may check each layer to see whether an enable flag (FIG. 3C-344) has been set for each layer. If the enable flag is set (i.e., the layer is enabled), display processor 114 may combine or process the enabled surfaces of the layer with enabled surfaces of the other enabled layers in overlay stack 320. If the enable flag is not set (i.e. the layer is disabled), display processor 114 may not combine or process any surfaces bound to the layer with the enabled surfaces of other layers in overlay stack 320. The enable flags within overlay stack 320 may be set or reset by a user program or API instruction executing on one of programmable processors 108, 110, 114. In this manner, a user program may selectively enable and disable entire layers and/or individual surfaces and/or the complete overlay stack for any particular graphics frame.

FIG. 3C is a block diagram illustrating an example layer 340 that may be used in overlay stack 320. Layer 340 may be either an overlay layer, an underlay layer, or a base layer. Layer 340 includes layer level data 342, enable flag 344, and rendered surface data 346A-346N (collectively, 346). Layer level data 342 indicates the level at which layer 340 resides in overlay stack. In cases where an individual bound surface has a surface level, the surface level will be identical to the layer level of the layer to which the surface is bound.

Enable flag 344 determines whether layer 340 is enabled or disabled. If enable flag 344 is set for layer 340, then layer 340 is enabled, and display processor 114 may combine or process all enabled surfaces bound to layer 340 into a resulting graphics frame. Otherwise, if enable flag 344 is not set, layer 340 is disabled, and display processor 114 may not use or process any enabled surfaces within layer 340 when generating the resulting graphics frame. In some cases, window surface 322 in overlay stack 320 may be a part of a base layer. According to one aspect, the base layer may not be disabled. In other aspects, the base layer may be disabled.

Rendered surface data 346 may correspond to the rendered surface data stored in the surface information block 124 of memory 104 or within surface buffer 112 of graphics processing system 102. In some cases, layer 340 may include entire surface profiles 200 for a rendered surface, while in other cases layer 340 may contain address pointers that point to other data structures that contain surface information for processing by overlay stack 200. In any case, a user program executing on one of programmable processors 108, 110, 114 may associate (i.e. bind) surfaces to a particular layer within overlay stack 320. When a surface is bound to a layer, the layer will contain rendered surface data 346 or information pointing to the appropriate rendered surface data for that particular surface.

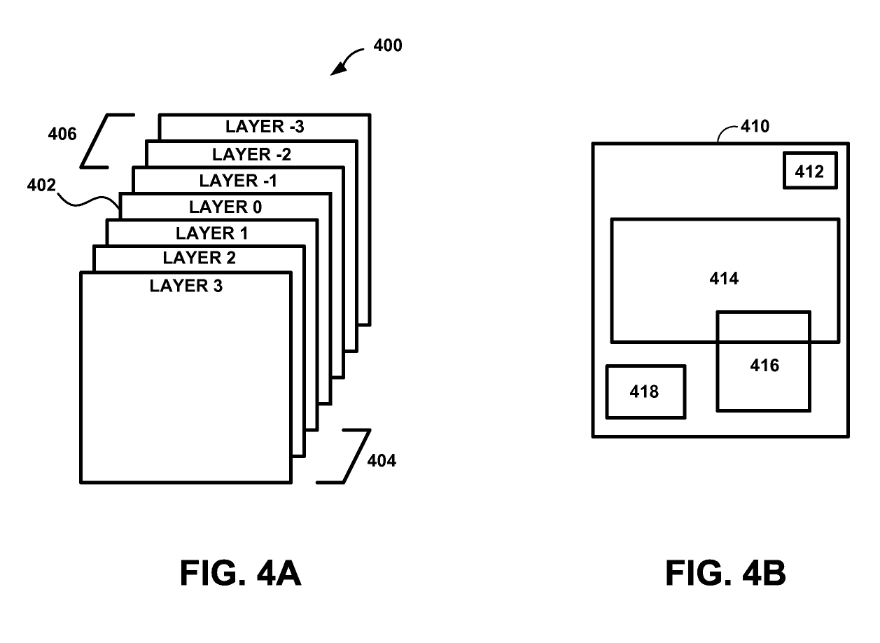

FIG. 4A is a conceptual diagram depicting an example of an overlay stack 400 and the relationship between overlay layers, underlay layers, and a base layer. Overlay stack 400 may be similar in structure to overlay stack 320 shown in FIG. 3B. As shown in FIG. 4A, “Layer 3” appears closest to the viewer of a display and “Layer-3” appears farthest away from the viewer of the display. Layer 402 has a layer level of zero and is defined as the base layer for overlay stack 400. Base layer 402 may contain a window surface, which may be rendered by graphics processor 110 and stored as a rendered surface within surface buffer 112. The positive layers (i.e., “Layer 1”, “Layer 2”, and “Layer 3”) are defined as overlay layers 404 because the layers overlay or appear in front of base layer 402. The negative layers (i.e., “Layer-1”, “Layer-2” and “Layer-3”) are defined as underlay layers because the layers underlay or appear behind base layer 402. In other words, these layers are occluded by base layer 402. According to one aspect, as shown in FIG. 4A, the more positive the layer level, the closer the surface appears to the viewer of display device 106 (FIG. 1). Likewise, the more negative the layer level, the farther away the surface appears to the viewer of display device 106. In other words, objects contained in surfaces that have higher surface levels may appear in front of objects contained in surfaces that have lower surface levels, and objects contained in surfaces that have lower surface levels may appear in back of or behind objects contained in surfaces that have higher surface levels.

Each layer may have one or more surfaces bound to the layer. In one aspect, base layer 402 must have an on-screen window surface bound to the layer. The on-screen surface may be rendered by graphics processor 110 for each successive graphics frame. Additionally, according to this aspect, only off-screen surfaces (i.e., pbuffers, pixmaps) may be bound to both overlay layers 404 and underlay layers 406. The off-screen surfaces may be rendered by any of programmable processors 108, 110, or 114 as well as retrieved from memory 104, such as from surface information 124.

FIG. 4B illustrates an example layer 410 in greater detail. Layer 410 may be a layer within overlay stack 400 illustrated in FIG. 4A including any one of base layer 402, overlay layers 404, or underlay layers 406. Layer 410 includes surfaces 412, 414, 416, 418. In some aspects, surfaces 412, 414, 416, 418 may all be off-screen surfaces. Each of surfaces 412, 414, 416, 418 may be bound to layer 410 by one of programmable processors 108, 110, 114 in response to an API instruction or user program instruction. In general, each surface within a layer is assigned the same surface level, which may correspond to the layer level. For example, if layer 410 is “Layer 3” in overlay stack 400, each of surfaces 412, 414, 416, 418 may be assigned a surface level of three. In cases where two surfaces, which are bound to the same layer, overlap each other, such as surfaces 414 and 416 in layer 410, the surfaces may be rendered in the order in which they are bound. For example, if surface 416 was bound after surface 414, surface 416 may appear closer to the viewer than surface 414. Otherwise, if surface 416 was bound prior to surface 414, surface 414 may appear closer to the viewer. In other cases, a different rendering order may be used for overlapping surfaces such as, for example, rendering in the opposite order in which the surfaces were bound to the layer.

Display processor 114 may combine the layers and surfaces in overlay stack 400 to generate a resulting graphics frame that can be sent to frame buffer 160 or display 106. Display processor 114 may combine the graphics surfaces according to one or more compositing modes, such as, for example: (1) overwriting, (2) alpha blending, (3) color-keying without alpha blending, and (4) color-keying with alpha blending.

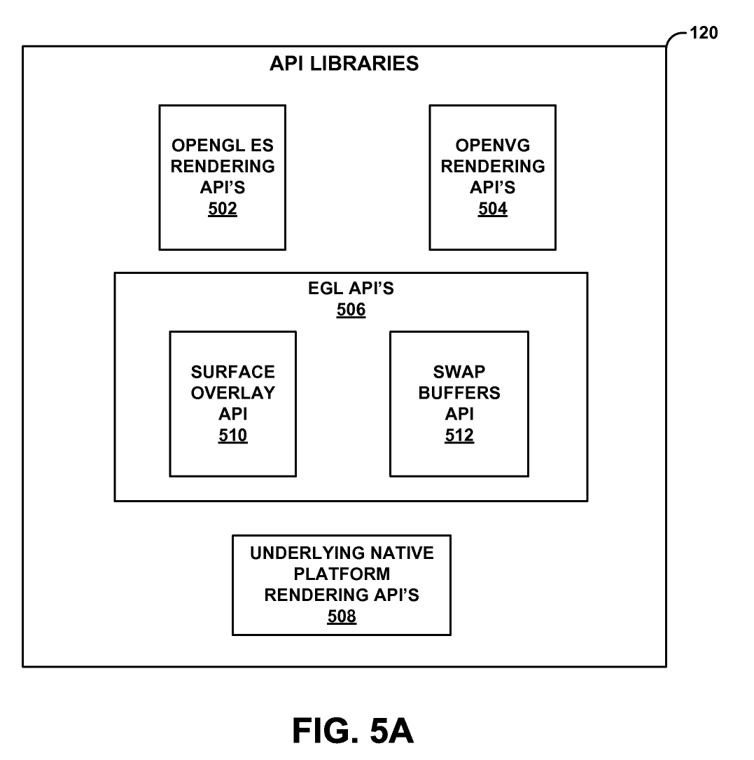

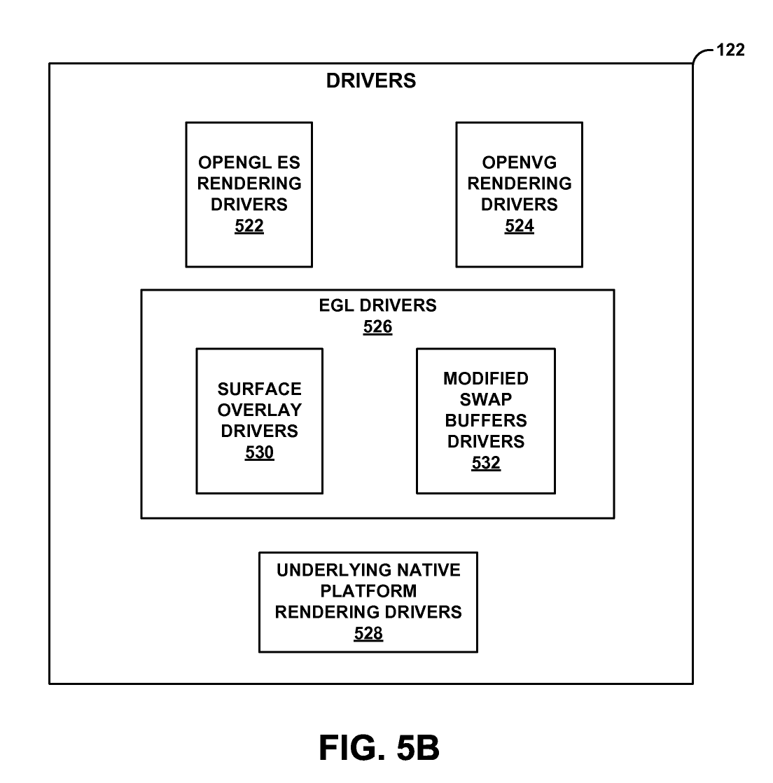

FIG. 5A is a block diagram illustrating further details of API libraries 120 shown in FIG. 1, according to one aspect. As described previously with reference to FIG. 1, API libraries 120 may be stored in memory 104 and linked, or referenced, by application instructions 118 during application execution by graphics processor 110, control processor 108, and/or display processor 114. FIG. 5B is a block diagram illustrating further details of drivers 122 shown in FIG. 1, according to one aspect. Drivers 122 may be stored in memory 104 and linked, or referenced, by application instructions 118 and/or API libraries 120 during application execution by graphics processor 110, control processor 108, and/or display processor 114.

In the example of FIG. 5A, API libraries 120 includes OpenGL ES rendering API's 502, OpenVG rendering API's 504, EGL API's 506, and underlying native platform rendering API's 508. Drivers 122, shown in FIG. 5B, include OpenGL ES rendering drivers 522, OpenVG rendering drivers 524, EGL drivers 526, and underlying native platform rendering drivers 528. OpenGL ES rendering API's 502 are API's invoked by application instructions 118 during application execution by graphics processing system 102 to provide rendering functions supported by OpenGL ES, such as 2D and 3D rendering functions. OpenGL ES rendering drivers 522 are invoked by application instructions 118 and/or OpenGL ES rendering API's 502 during application execution for low-level driver support of OpenGL ES rendering functions in graphics processing system 102.

OpenVG rendering API's 504 are API's invoked by application instructions 118 during application execution to provide rendering functions supported by OpenVG, such as 2D vector graphics rendering functions. OpenVG rendering drivers 524 are invoked by application instructions 118 and/or OpenVG rendering API's 504 during application execution for low-level driver support of OpenVG rendering functions in graphics processing system 102.

EGL API's 506 (FIG. 5A) and EGL drivers 526 (FIG. 5B) provide support for EGL functions in graphics processing system 102. EGL extensions may be incorporated within EGL API's 506 and EGL drivers 526. The term EGL extension may refer to a combination of one or more EGL API's and/or EGL drivers that extend or add functionality to the standard EGL specification. The EGL extension may be created by modifying existing EGL API's and/or existing EGL drivers, or by creating new EGL API's and/or new EGL drivers. In the examples of FIGS. 5A-5B, a surface overlay EGL extension is provided as well as supporting modifications to the EGL standard function eglSwapBuffers. Thus, for the EGL surface overlay extension, a surface overlay API 510 is included within EGL API's 506 and a surface overlay driver 530 is included within EGL drivers 526. For the modified EGL function eglSwapBuffers, a standard swap buffers API 512 is included within EGL API's 506 and a modified swap buffers driver 532 is included within EGL drivers 526.

The EGL surface overlay extension provides a surface overlay stack for overlaying of multiple graphics surfaces (such as 2D surfaces, 3D surfaces, and/or video surfaces) into a single graphics frame. The graphics surfaces may each have an associated surface level within the stack. The overlay of surfaces is thereby achieved according to an overlay order of the surfaces within the stack. In one aspect, the EGL surface overlay extension may provide functions for the creation and maintenance of overlay stacks. For example, the EGL surface overlay extension may provide functions to allow a user program or other API to create an overlay stack and bind surfaces to various layers within the overlay stack. The EGL surface overlay stack may also allow a user program or API function to selectively enable or disable surfaces or entire layers within the overlay stack, as well as to selectively enable or disable the overlay stack itself. Finally, the EGL surface overlay API may provide functions that return surface binding configurations as well as surface level information to a user program or client API. In this manner, the EGL surface overlay extension provides for the creation and management of an overlay stack that contains both on-screen surfaces and off-screen surfaces.

The modified swap buffers driver 532 may perform complex calculations on the surfaces in the overlay stack and set up various data structures that are used by display processor 114 when combining the surfaces. In order to prepare this data, the modified swap buffers driver 532 may traverse the overlay stack beginning with the layer that has the lowest level and proceeding in order up to base layer, which contains the window surface. Within each layer, driver 532 may proceed by processing each surface in the order in which it was bound to the layer. Then, driver 532 may process the base layer (i.e., layer 0) containing the window surface, and in some cases, other surfaces. Finally, driver 532 will proceed to process the overlay layers, starting with layer level 1 and proceeding in order up to the highest layer, which appears closest to the viewer of the display. In this manner, modified EGL swap buffers driver 532 systematically processes each surface in order to prepare data for display processor 114 to use when rendering the graphics frame.

As is shown in FIG. 5A, API libraries 120 also includes underlying native platform rendering API's 508. API's 508 are those API's provided by the underlying native platform implemented by device 100 during execution of application instructions 118. EGL API's 506 provide a platform interface layer between underlying native platform rendering API's 508 and both OpenGL ES rendering API's 502 and OpenVG rendering API's 504. As is shown in FIG. 5B, drivers 122 includes underlying native platform rendering drivers 528. Drivers 528 are those drivers provided by the underlying native platform implemented by device 100 during execution of application instructions 118 and/or API libraries 120. EGL drivers 526 provide a platform interface layer between underlying native platform rendering drivers 528 and both OpenGL ES rendering drivers 522 and OpenVG rendering drivers 524.

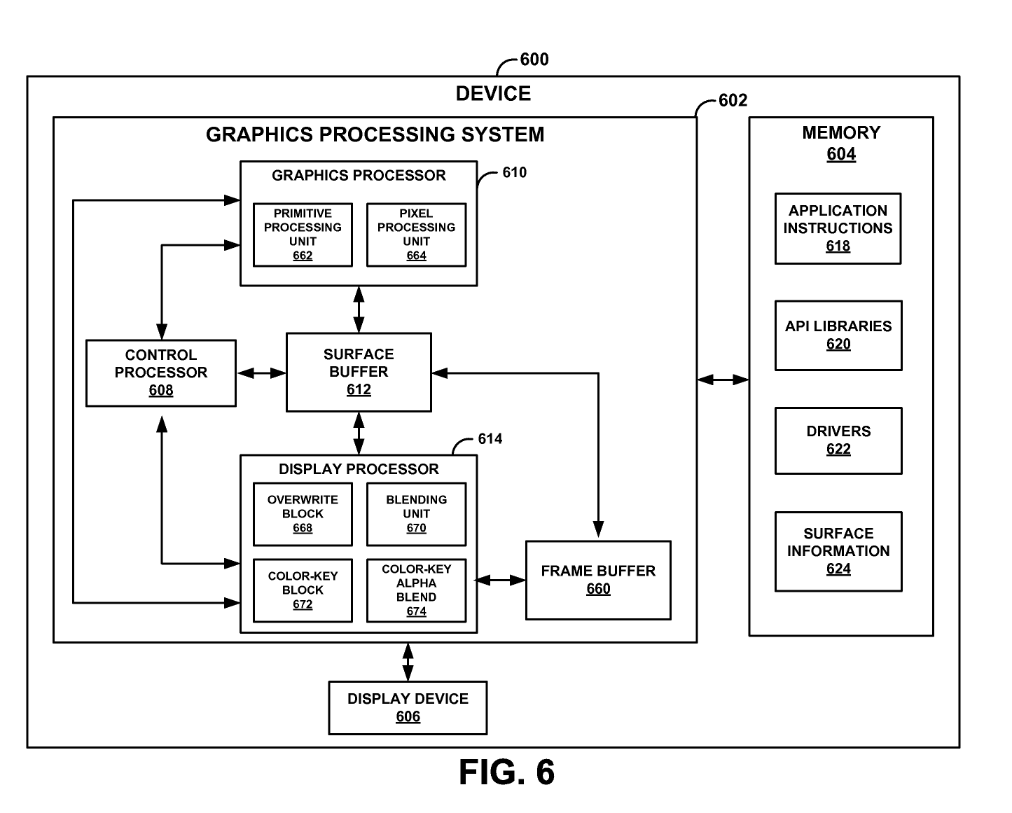

FIG. 6 is a block diagram illustrating a device 600 that may be used to overlay or combine a set of rendered graphics surfaces onto a graphics frame, according to another aspect of this disclosure. In this aspect, device 600 shown in FIG. 6 is an example instantiation of device 100 shown in FIG. 1. Device 600 includes a graphics processing system 602, memory 604, and a display device 606. Similar to memory 104 shown in FIG. 1, memory 604 of FIG. 6 includes storage space for application instructions 618, API libraries 620, drivers 622, and surface information 624. Similar to graphics processing system 102 shown in FIG. 1, graphics processing system 602 of FIG. 2 includes a control processor 608, a graphics processor 610, a display processor 614, a surface buffer 612, and a frame buffer 660. Although shown as included within graphics processing system 602 in FIG. 6, one or both of surface buffer 612 and frame buffer 660 may also, in one aspect, be included directly within memory 604.

Graphics processor 610 includes a primitive processing unit 662 and a pixel processing unit 664. Primitive processing unit 662 performs operations with respect to primitives within graphics processing system 602. Primitives are defined by vertices and may include points, line segments, triangles, rectangles. Such operations may include primitive transformation operations, primitive lighting operations, and primitive clipping operations. Pixel processing unit 664 performs pixel operations upon individual pixels or fragments within graphics processing system 602. For example, pixel processing unit 664 may perform pixel operations that are specified in the OpenGL ES API. Such operations may include pixel ownership testing, scissors testing, multisample fragment operations, alpha testing, stencil testing, depth buffer testing, blending, dithering, and logical operations

Display processor 614 combines two or more surfaces within graphics processing system 602 by overlaying and underlaying surfaces in accordance with an overlay stack and a selected compositing algorithm. The compositing algorithm may be based on a selected compositing mode, such as, for example: (1) overwriting, (2) alpha blending, (3) color-keying without alpha blending, and (4) color-keying with alpha blending. Display processor 614 includes an overwrite block 668, a blending unit 670, a color-key block 672, and a combined color-key alpha blend block 674.

Overwrite block 668 performs overwriting operations for display processor 614. Where two or more rendered graphics surfaces overlap, overwrite block 668 may select one of the rendered graphics surfaces having a highest surface level, and format the graphics frame such that the selected one of the rendered graphics surfaces is displayed for overlapping portions of the rendered graphics surfaces.

Blending unit 670 performs blending operations for display processor 614. The blending operations may include, for example, a full surface constant alpha blending operation and a full surface per-pixel alpha blending operation.

Color-key block 672 performs color-key operations without alpha blending. For example, color-key block 672 may check each pixel within the overlapping portion of the higher surface of two overlapping surfaces to determine which pixels match a key color (e.g. magenta). For any pixels that match the key color, color-key block 672 may chose the corresponding pixel from the lower surface (i.e., the pixel having the same display location) as the output pixel (i.e., displayed pixel). For any pixels that do not match the key color, color-key block 672 may choose the pixel from the higher surface as the output pixel.

Combined color-key alpha blend block 674 performs color-keying operations as well as alpha blending operations. For example, block 674 may check each pixel within the overlapping portion of the higher surface of two overlapping surfaces to determine which pixels match the key color. For any pixels that match the key color, block 674 may choose the corresponding pixel from the lower surface (i.e., the pixel having the same display location) as the output pixel. For any pixels that do not match the key color, block 674 may blend the pixel of the higher surface with the corresponding pixel from the lower surface to generate the output pixel.

Although display processor 614 is shown in FIG. 6 as having four exemplary operating blocks, in other examples, display processor 614 may have more or less operating blocks that perform various pixel blending and keying algorithms. In some cases, the total number of unique pixel operations that display processor 614 is capable of performing may be less than the total number of unique pixel operations graphics processor 610 is capable of performing. Display processor 114 may also perform other post-rendering functions on a rendered graphics surface or frame, including scaling and rotation.

By dividing up graphics processing into a graphics processor 610 that performs complex rendering and a display processor 614 that combines on-screen and off-screen surfaces, and by operating processors 610 and 614 in parallel, the clock rate of graphics processor 610 can be reduced. Moreover, because power consumption increases nonlinearly with the clock rate of graphics processor 610, significant power savings can be achieved in graphics processing system 602.

In some aspects, display processor 614 may include a graphics pipeline that is less complex than graphics pipeline in graphics processor 610. For example, the graphics pipeline in display processor 614 may not perform any primitive operations. As another example, the total number of pixel operations provided by blending unit 670 may be less than the total number of pixel operations provided by pixel processing unit 664. By including a reduced amount of operations within display processor 614, the graphics pipeline may be simplified and streamlined to provide significant power savings and increase the throughput in graphics processing system 602.

In one aspect, a graphics application may contain many objects that are relatively static between successive frames. In video game applications, examples of static objects may include crosshairs, score boxes, timers, speedometers, and other stationary or unchanging elements shown on a video game display. It should be noted that a static object may have some movement or changes between successive graphic frames, but the nature of these movements or changes may often not require a re-rendering of the entire object from frame to frame. In graphics processing system 602, static objects can be assigned to off-screen surfaces and rendered by using a graphics pipeline that is less complex than the complex graphics pipeline that may be used in graphics processor 610. For example, control processor 608 may be able to render simple 2D surfaces using less power than graphics processor 610. These surfaces can then be rendered by control processor 608 and sent directly to display processor 614 for combination with other surfaces that may be more complex. In this example, the combined graphics pipeline that is used to render a static 2D surface (i.e. control processor 608 and display processor 614) may consume less power than the complex graphics pipeline of graphics processor 610. On the other hand, graphics processor 610 may be able to render complex 3D graphics more efficiently than control processor 608. Thus, device 600 may be used to more efficiently render graphics surfaces by selectively choosing different graphics pipelines depending upon the characteristics of the objects to be rendered.

As another example, control processor 608 may retrieve, or direct display processor 614 to retrieve, pre-rendered surfaces that are stored in memory 604 or surface buffer 612. The pre-rendered surfaces may be provided by a user application or may be generated by graphics processing system 602 when resources are less heavily utilized. Control processor 608 may assign a surface level to each of the pre-rendered surfaces and direct display processor 614 to combine the pre-rendered surfaces with other rendered surfaces in accordance with the selected surface levels. In this manner, the pre-rendered surfaces completely bypass the complex graphics pipeline in graphics processor 610, which provides significant power savings to device 600.

As yet another example, some objects may be relatively static, but not completely static. For example, a car-racing game may have a speedometer dial with a needle that indicates the current speed of the car. The speedometer dial may be completely static because the dial does not change or move in successive frames, and the needle may be relatively static because the needle moves slightly from frame to frame as the speed of the car changes. Rather than render the needle every frame using the complex graphics pipeline in graphics processor 610, several different instantiations of the needle may be provided on different pre-rendered surfaces. For example, each pre-rendered surface may depict the needle in a different position to indicate a different speed of the car. All of these surfaces may be bound to an overlay stack. Then, as the speed of the car changes, control processor 208 can enable an appropriate instantiation of the needle that indicates the current speed of the car and disable the other instantiations of the needle. Thus, the needle, which may change position between successive frames, does not need to be rendered every frame by either control processor 608 or graphics processor 610. By selectively enabling and disabling pre-rendered surfaces, device 600 is able to more efficiently render graphics frames.

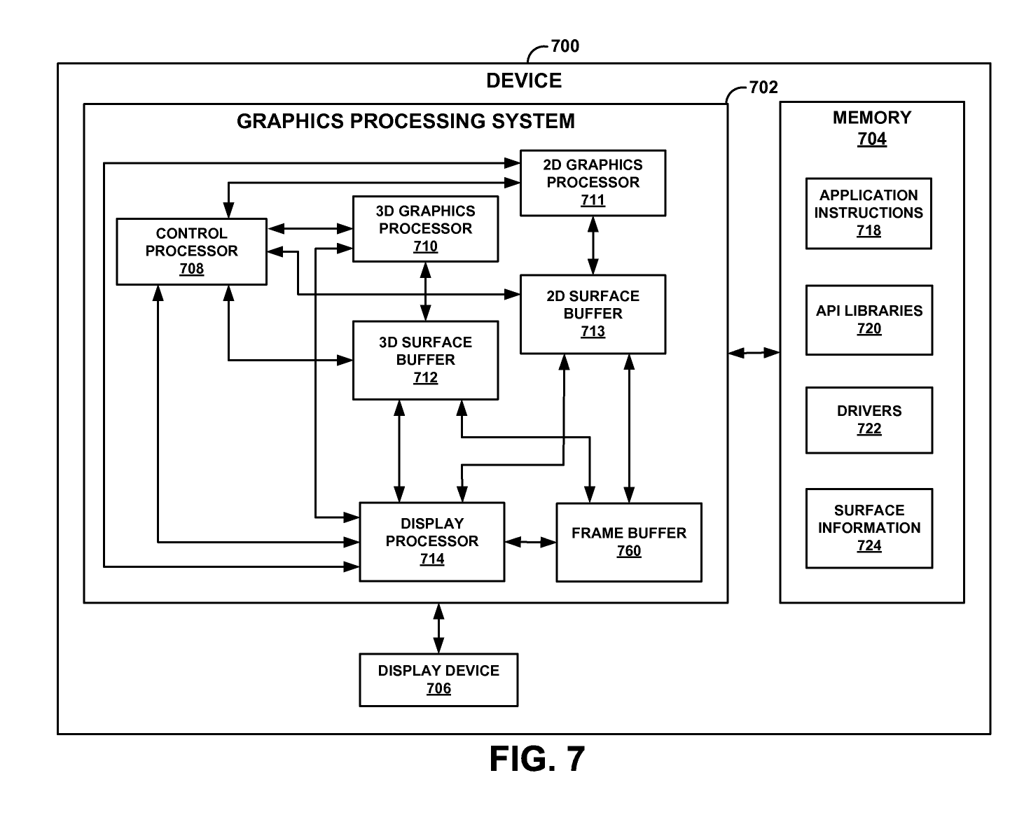

FIG. 7 is a block diagram illustrating a device 700 that may be used to overlay or combine a set of rendered graphics surfaces onto a graphics frame, according to another aspect of this disclosure. FIG. 7 depicts a device 700 similar in structure to device 100 shown in FIG. 1 except that two graphics processors are included as well as two surface buffers. Device 700 includes a graphics processing system 702, memory 704, and a display device 706. Similar to memory 104 shown in FIG. 1, memory 704 of FIG. 7 includes storage space for application instructions 718, API libraries 720, drivers 722, and surface information 724. Similar to graphics processing system 102 shown in FIG. 1, graphics processing system 702 of FIG. 7 includes a control processor 708, a display processor 714, and a frame buffer 760. Although shown as included within graphics processing system 702 in FIG. 7, any of surface buffer 712, surface buffer 713, and frame buffer 760 may also, in some aspects, be included directly within memory 704.

Graphics processing system 702 also includes a 3D graphics processor 710, a 2D graphics processor 711, a 3D surface buffer 712, and a 2D surface buffer 713. As shown in FIG. 7, each of graphics processors 710, 711 are operatively coupled to control processor 708 and display processor 714. In addition, each of surface buffers 712, 713 are operatively coupled to control processor 708, display processor 714, and frame buffer 760. 3D graphics processor 710 is operatively coupled to 3D surface buffer 712 to form a 3D graphics processing pipeline within graphics processing system 702. Similarly, 2D graphics processor 711 is operatively coupled to 2D surface buffer 713 to form a 2D graphics processing pipeline within graphics processing system 702. Similar to surface buffer 112 in FIG. 1, 3D surface buffer 712 and 2D surface buffer 713 may each comprise one or more surface buffers, and each of the one or more surface buffers may store one or more rendered surfaces.

In one aspect, 3D graphics processor 710 may include an accelerated 3D graphics rendering pipeline that efficiently implements 3D rendering algorithms. 2D graphics processor 711 may include an accelerated 2D graphics rendering pipeline that efficiently implements 2D rendering algorithms. For example, 3D graphics processor 710 may efficiently render surfaces in accordance with OpenGL ES API commands, and 2D graphics processor 711 may efficiently render surfaces in accordance with OpenVG API commands.

In graphics processing system 702, control processor 708 may render 3D surfaces using the 3D rendering pipeline (i.e., 710, 712), and may also render 2D surfaces using 2D rendering pipeline (i.e., 711, 713). For example, 3D graphics processor 710 may render a first set of rendered graphics surfaces and store the first set of rendered graphics surfaces in 3D surface buffer 712. Likewise, 2D graphics processor 711 may render a second set of rendered graphics surfaces and store the second set of rendered graphics surfaces in 2D surface buffer 713. Display processor 714 may retrieve 3D rendered graphics surfaces from surface buffer 712 and 2D rendered graphics surfaces from surface buffer 713 and overlay the 2D and 3D surfaces in accordance with surface levels selected for each surface or in accordance with an overlay stack. In this example, each of the rendering pipelines has a dedicated surface buffer to store rendered 2D and 3D surfaces. Because of the dedicated surface buffers 712, 713 within graphics processing system 702, processors 710 and 711 may not need to be synchronized with each other. In other words, 3D graphics processor 710 and 2D graphics processor 711 can operate independently of each other without having to coordinate the timing of surface buffer write operations, according to one aspect. Because the processors do not need to be synchronized, throughput within the graphics processing system 702 is improved. Thus, graphics processing system 702 provides for efficient rendering of surfaces by using a separate 3D graphics acceleration pipeline and a separate 2D graphics acceleration pipeline.

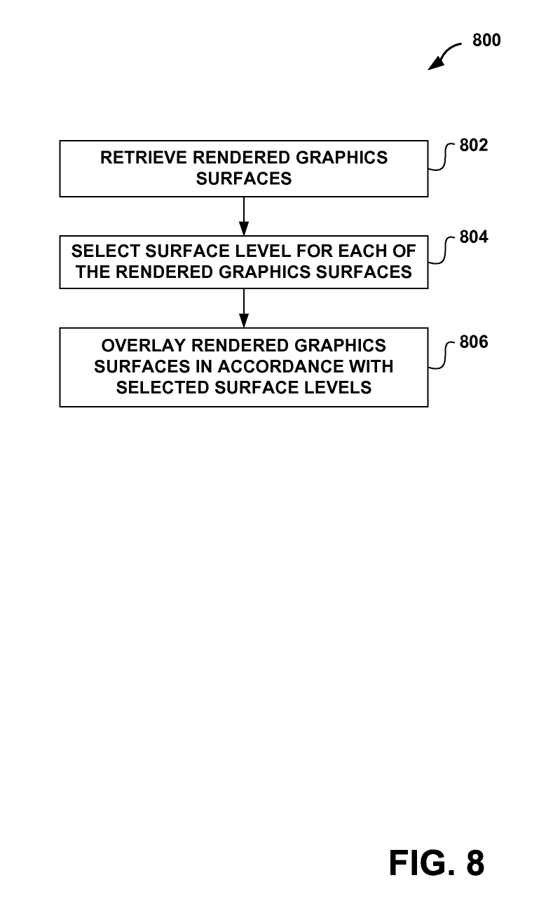

FIG. 8 is a flowchart of a method 800 for overlaying or combining rendered graphics surfaces. For purposes of illustration, the subsequent description describes the performance of method 800 with respect to device 100 in FIG. 1. However, method 800 can be performed using any of the devices shown in FIG. 1, 6, or 7. Moreover, in some cases, the description may specify that a particular programmable processor performs a particular operation. It should be noted, however, that one or more of programmable processors 108, 110, 114 may perform any of the actions described with respect to method 800.

As shown in FIG. 8, display processor 114 may retrieve a plurality of rendered graphics surfaces (802). The rendered graphics surfaces may be generated or rendered by one of programmable processors 108, 110, or 114. In one aspect, one of programmable processors 108, 110, or 114 may store the rendered graphics surfaces within one or more surface buffers 112 or within memory 104, and display processor 114 may retrieve the rendered graphics surfaces from the one or more surface buffers 112 or from memory 104. In some aspects, graphics processor 110 may render the surfaces at least in part by using an accelerated 3D graphics pipeline. In addition, control processor 108 may render one or more graphics surfaces at least in part by using a general purpose processing pipeline. In one aspect, graphics processing system 102 may pre-render one or more graphics surfaces and store the pre-rendered graphics surfaces either in memory 104 or surface buffer 112. In some cases, processors 108 or 110 may send the rendered surface directly to display processor 114 without storing the rendered surface in surface buffer 112.

A surface level is selected for each of the rendered graphics surfaces (804). For example, either control processor 108 or graphics processor 110 may select a surface level for the rendered surfaces and store the selected surface levels 117 in surface buffer 112. In another aspect, application instructions 118 or API functions in API libraries 120 may select the surface levels and store the selected surface levels 117 in surface buffer 112. In some aspects, the selected surface levels may be selected by binding the rendered surfaces to an overlay stack. The overlay stack may contain a plurality of layers each having a unique layer level. The surface levels may be selected by selecting a particular layer in the overlay stack for each rendered surface, and binding each rendered surface to the layer selected for the surface. When two or more surfaces are bound to the same layer, the surface levels may be further selected by determining a binding order for the two or more surfaces. In some cases, the selected surface levels may be sent directly to display processor 114 without storing the surface levels within surface buffer 112. In one aspect, the surface level for each of the rendered graphics surfaces may be selected prior to outputting any of the rendered graphics surfaces to the display. In another aspect, the surface level for a particular rendered graphics surfaces may be selected prior to rendering the particular surface.

Display processor 114 overlays the rendered graphics surfaces onto a graphics frame in accordance with the selected surface levels (806). Overlaying the rendered graphics surfaces may include combining a rendered surface with one or more other rendered graphics surfaces. In one aspect, display processor 114 may combine the graphics surfaces according to one or more compositing or blending modes. Examples of such compositing modes include (1) overwriting, (2) alpha blending, (3) color-keying without alpha blending, and (4) color-keying with alpha blending. When display processor 114 combines the rendered graphics surfaces according to the overwriting compositing mode and two or more rendered graphics surfaces overlap, display processor 114 may select one of the rendered graphics surfaces having a highest surface level, and format the graphics frame such that the selected one of the rendered graphics surfaces is displayed for overlapping portions of the rendered graphics surfaces. Display processor 114 may combine the surfaces in accordance with an overlay stack that defines a plurality of layers. Each layer may have a unique layer level and include one or more surfaces that are bound to the layer. Display processor 114, in some cases, may then traverse the overlay stack to determine the order in which the surfaces are combined. When two or more surfaces are bound to the same layer, display processor may further determine the order in which the surfaces are combined by determining the binding order for the two or more surfaces. When overlaying the rendered graphics surfaces according to the overlay stack, display processor 114 may format the graphics frame such that when the graphics frame is displayed on the display, rendered graphics surfaces bound to a layer having a first layer level within the overlay stack appear closer to a viewer of the display than rendered graphics surfaces bound to layers having layer levels lower than the first layer level. After display processor 114 overlays the rendered graphics surfaces, display processor 114 may output the graphics frame to frame buffer 160 or to display 106.

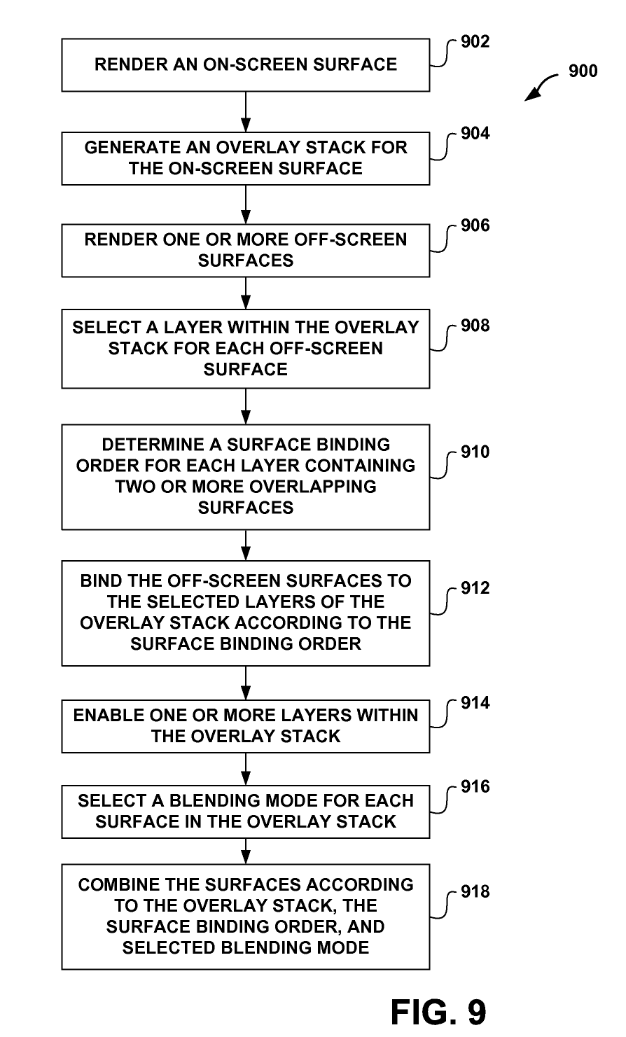

FIG. 9 is a flowchart of a method 900 for overlaying or combining rendered graphics surfaces. For purposes of illustration, the following description describes the performance of method 900 with respect to device 100 in FIG. 1. However, method 900 can be performed using any of the devices shown in FIG. 1, 6, or 7. Moreover, in some cases, the description may specify that a particular programmable processor performs a particular operation. It should be noted, however, that one or more of programmable processors 108, 110, 114 may perform any of the actions described with respect to method 900. In addition, method 900 is merely an example of a method that employs the techniques described in this disclosure. Thus, the ordering of the operations can vary from the order shown in FIG. 9.

Graphics processor 110 may render an on-screen surface (902). The on-screen surface may be a window surface and may be rendered using an accelerated 3D graphics pipeline. One of programmable processors 108, 110, 114 may generate an overlay stack for the on-screen surface (904). The overlay stack may have a plurality of layers and be stored in surface information block 124 of memory 104, within surface buffer 112, or within other buffers (not shown) within graphics processing system 102. One of programmable processors 108, 110 may render one or more off-screen surfaces (906). Example off-screen surfaces may include pbuffer surfaces and pixmap surfaces. In some cases, these surfaces may be rendered by using a general purpose processing pipeline. One of programmable processors 108, 110, 114 may select a layer within the overlay stack for each off-screen surface (908). As an example, the window surface may be bound to a base layer (i.e., layer zero) within the overlay stack, and the selected layers may comprise overlay layers, which overlay or appear in front of the base layer, and underlay layers, which underlay or appear behind the base layer. In one aspect, the selected layers may also comprise the base layer.

As further shown in FIG. 9, one of programmable processors 108, 110, 114 determines a surface binding order for each layer containing two or more overlapping surfaces (910). The surface binding order may be based on the desired display order of the surfaces for a given layer. For example, a surface bound to a particular layer may appear behind any surface that was bound to the same layer at a later time. One of programmable processors 108, 110, 114 may bind the off-screen surfaces to individual selected layers of the overlay stack according to the surface binding order (912). In one aspect, one of programmable processors 108, 110, 114 may bind on-screen surfaces to layers within the overlay stack in addition to off-screen surfaces. One of programmable processors 108, 110, 114 may then selectively enable or disable individual surfaces or layers within the overlay stack for each graphics frame to be displayed (914), and then select a compositing or blending mode for each surface bound to the overlay stack (916). The compositing or blending mode may be one of simple overwrite, color-keying with constant alpha blending, color-keying without constant alpha blending, full surface constant alpha blending, or full surface per-pixel alpha blending. Finally, display processor 114 combines or overlays the surfaces according to the overlay stack, the surface binding order, and selected blending mode (918). In one aspect, when a layer within the overlay stack is enabled for a graphics frame, display processor 114 may process each of the rendered graphics surfaces bound to the layer to generate the graphics frame. Likewise, when a layer within the overlay stack is disabled for the graphics frame, display processor 114 may not process any rendered graphics surfaces bound to the layer to generate the graphics frame. In another aspect, when a rendered graphics surface is enabled for a graphics frame, display processor 114 may process the rendered graphics surface to generate the first graphics frame. Conversely, when the rendered graphics surface is disabled for the first graphics frame, display processor 114 may not process the rendered graphics surface to generate the first graphics frame. In some cases, a window surface associated with the overlay stack may be considered to be a primary window surface. According to one aspect, the primary window surface may not be disabled. In other aspects the primary window surface may be disabled.

In one aspect, an EGL extension is provided for combining a set of EGL surfaces to generate a resulting graphics frame. The EGL extension may provide at least seven new functions related to setting up an overlay stack and combining surfaces. Example function declarations for seven new functions are shown below:

| | |
|---|---|
| EGLSurface eglCreateCompositeSurfaceQUALCOMM( | EGLDisplay dpy, |
| | EGLSurface win, |
| | const EGLint |
| | *attrib_list ); |

| | |
|---|---|
| EGLBoolean eglSurfaceOverlayEnableQUALCOMM ( | EGLDisplay dpy, |
| | EGLSurface surf, |
| | EGLBoolean enable ); |

| | |
|---|---|
| EGLBoolean eglSurfaceOverlayLayerEnableQUALCOMM ( | EGLDisplay dpy, |
| | EGLSurface |
| comp_surf, | |
| | EGLint layer, |
| | EGLBoolean enable ); |

| | |
|---|---|
| EGLBoolean eglSurfaceOverlayBindQUALCOMM ( | EGLDisplay dpy, |
| | EGLSurface comp_surf, |
| | EGLSurface surf, |
| | EGLint layer, |
| | EGLBoolean enable ); |

| | |
|---|---|
| EGLBoolean eglGetSurfaceOverlayBindingQUALCOMM ( | EGLDisplay dpy, |
| | EGLSurface surf, |
| | EGLSurface |
| *comp_surf, | |
| | EGLint *layer); |

| | |
|---|---|
| EGLBoolean eglGetSurfaceOverlayQUALCOMM ( | EGLDisplay dpy, |
| | EGLSurface surf, |
| | EGLBoolean *layer_enable, |
| | EGLBoolean *surf_enable ); |

| | |
|---|---|
| EGLBoolean eglGetSurfaceOverlayCapsQUALCOMM ( | EGLDisplay dpy, |
| | EGLSurface win, |
| | EGLCompositeSurfaceCaps |
| | *param); |

The eglCreateCompositeSurfaceQUALCOMM function may be called to create a composite surface and/or overlay stack. The eglSurfaceOverlayEnableQUALCOMM function may be called to enable or disable an entire overlay stack or individual surfaces associated with an overlay stack. The eglSurfaceoverlayLayerEnableQUALCOMM function may be called to enable or disable a particular layer within an overlay stack. The eglSurfaceoverlayBindQUALCOMM function may be called to bind or attach a surface to a particular layer within an overlay stack. The eglGetSurfaceoverlayBindingQUALCOMM function may be called to determine the composite surface (i.e. overlay stack) and layer within the overlay stack to which a particular surface is bound. The eglGetSurfaceoverlayQUALCOMM function may be called to determine whether a particular surface is enabled as well as whether the layer to which that surface is bound is enabled. The eglGetSurfaceoverlayCapsQUALCOMM function may be called to receive the implementation limits for composite surfaces in the specific driver and hardware environment.

In one aspect, the EGL extension may provide additional data type structures. One such structure provides implementation limits for a composite surface (i.e. overlay stack). The composite surface may store or otherwise be associated with an overlay stack. An example data structure is shown below:

| | |
|---|---|
| typedef struct | |
| { | |
| EGLint | max_overlay; |
| EGLint | max_underlay; |
| EGLint | max_surface_per_layer; |
| EGLint | max_total_surfaces; |
| EGLBoolean | pbuffer_support; |
| EGLBoolean | pixmap_support; |

} EGLCompositeSurfaceCaps;

The four EGLint members provide respectively: the maximum number of overlay layers allowed for the composite surface; the maximum number of underlay surfaces allowed for a composite surface; the maximum number of surfaces allowed to be bound to or attached to each layer within the overlay stack; and the maximum total number of surfaces allowed to be bound to all layers within the overlay stack. The first EGLBoolean member provides information relating to whether the composite surface will support pbuffer surfaces, and the second EGLBoolean member provides information relating to whether the composite surface will support pixmap surfaces.

The EGL EGLSurface data structure may contain three additional members of type EGLCompSurf, EGLBoolean and EGLCompositeSurfaceCaps for a rendered surface. The EGLCompSurf member provides a pointer to the address of an associated composite surface, the EGLBoolean member determines whether the rendered surface is enabled, and the EGLCompositeSurfacecaps member provides information about the implementation limits of the associated composite surface.

The EGLCompSurf data structure may contain information relating to a composite surface (i.e. overlay stack). An example EGLCompSurf data structure is shown below:

| | |
|---|---|
| typedef struct | |
| { | |
| EGLBoolean | OverlayEnable |
| EGLSurface | WindowSurf |
| EGLCompLayer | *Overlays[MAX_OVLY] |
| EGLCompLayer | *Underlays[MAX_UNDLY] |
| } EGLCompSurf; | |

The EGLCompSurf data structure may contain at least four members for the composite surface: one member of type EGLBoolean; one member of type EGLSurface; and two array members of type pointer to EGLCompLayer. The EGLBoolean member provides an enable flag for the overlay stack, and the EGLSurface member provides a pointer to the associated window surface. The two EGLCompLayer array members provide an array of pointers to particular EGLCompLayer members that are within the overlay stack. The first EGLCompLayer array member may provide an array of address pointers to overlay layers within an overlay stack, and the second EGLCompLayer array member may provide an array of address pointers to underlay layers within an underlay stack.

The EGLCompLayer data structure may contain information relating to an individual layer within an overlay stack. An example EGLCompLayer data structure is shown below:

| | |
|---|---|
| typedef struct | |
| { | |
| EGLint | Level |
| EGLint | surf_count |
| EGLBoolean | OverlayEnable |
| EGLSurface | Surfaces[MAX_LAYER_SURF] |

} EGLCompLayer;

The EGLCompLayer data structure may contain at least four members for the composite surface: two members of type EGLint; one member of type EGLBoolean; and one array member of type EGLSurface. The first EGLint member provides the level of the layer, and the second EGLint member provides the total number of surfaces that are bound or attached to the layer. The EGLSurface array member provides an array of pointers to the surfaces that are bound or attached to the layer.

To create a particular composite surface, the function eglCreateCompositeSurfaceQUALCOMM may be called. The user program or API may pass several parameters to the function including a pointer to an EGLDisplay (i.e., an abstract display on which graphics are drawn) and a window surface of the type EGLSurface that will be used as the window surface for the overlay stack. In addition, the user program or API may pass an EGLint array data structure that defines the desired attributes of the resulting composite surface. The function may return a composite surface of type EGLSurface which includes an overlay stack.

To enable or disable an overlay stack or individual surfaces associated with a composite surface, the eglSurfaceoverlayEnableQUALCOMM function may be called. The user program or API may pass a pointer to the appropriate EGLDisplay as well as a pointer to an EGLSurface, which is either a composite surface that contains an overlay stack or an individual surface within an overlay stack. The user program or API also passes an EGLBoolean parameter indicating whether to enable or disable the surface. The function may return an EGLBoolean parameter indicating whether the function was successful or an error has occurred.

To enable or disable a particular layer within an overlay stack, the eglSurfaceoverlayLayerEnableQUALCOMM function may be called. The user program or API may pass a pointer to the appropriate EGLDisplay as well as a pointer to an EGLSurface, which is the composite surface that contains the overlay stack. The user program or API also passes an EGLint parameter indicating the desired layer within the overlay stack to be enabled or disabled. Finally, the user program or API also passes an EGLBoolean parameter indicating whether to enable or disable the layer contained within the overlay stack. The function may return an EGLBoolean parameter indicating whether the function was successful or an error has occurred.

To bind or attach a surface to a particular layer within an overlay stack, the eglSurfaceoverlayBindQUALCOMM function may be called. The user program or API may pass a pointer to the appropriate EGLDisplay as well as a pointer to an EGLSurface, which is the composite surface that contains the overlay stack. In addition, the user program or API may pass an address pointer to an EGLSurface that will be bound to the overlay stack and a value of type EGLint that indicates to which layer within the overlay stack the surface should be bound. Finally, the user program or API also passes an EGLBoolean parameter indicating whether to enable or disable the individual surface. The function may return an EGLBoolean parameter indicating whether the function was successful or an error has occurred.

To determine the layer within the overlay stack to which a particular surface is bound, the eglGetSurfaceoverlayBindingQUALCOMM function may be called. The user program or API may pass a pointer to the appropriate EGLDisplay as well as a pointer to the EGLSurface for which the layer information is sought. The user program or API also passes a pointer to an EGLSurface pointer, where the composite surface that contains the overlay stack is returned. Finally, the user program or API passes an EGLint pointer, which the function uses to return the layer level to which the surface is bound. The function may return an EGLBoolean parameter indicating whether the function was successful or an error has occurred.

To determine whether a particular surface is enabled as well as whether the layer to which that surface is bound is enabled, the eglGetSurfaceoverlayQUALCOMM function may be called. The user program or API may pass a pointer to the appropriate EGLDisplay as well as a pointer to an EGLSurface, which is the surface for which information is sought. The user program or API may also pass two EGLBoolean pointers, which the function uses to return information about the surface. The first EGLBoolean parameter indicates whether the layer to which the surface is bound is enabled, and the second EGLBoolean parameter indicates whether the particular surface is enabled. The function may return an EGLBoolean parameter indicating whether the function was successful or an error has occurred.

To receive the implementation limits for composite surfaces or overlay stacks associated with a particular native window, the eglGetSurfaceoverlayCapsQUALCOMM function may be called. The user program or API may pass a pointer to the appropriate EGLDisplay as well as a pointer to an EGLSurface, which is window surface for which implementation limits information is sought. In addition, the user program or API passes a pointer to data of type EGLCompositesurfacecaps, which the function uses to return the implementation limits for composite surfaces allowed for the particular window surface. The function may return an EGLBoolean parameter indicating whether the function was successful or an error has occurred.

To provide a usage example of an implementation of an EGL extension that supports combining a set of EGL surfaces to generate a resulting graphics frame, sample code is provided below. The sample code implements a scenario where a target device has a Video Graphics Array (VGA) Liquid Crystal Display (LCD) screen, but the application renders the 3D content to a Quarter Video Graphics Array (QVGA) window surface to improve performance and reduce power consumption. The code then scales the resolution up to a full VGA screen size once the layers are combined.

The application is a car racing game, which has a partial skybox in an underlay layer. The game also has an overlay layer which contains a round analog tachometer in the lower left corner, and a digital speedometer and gear indicator both located in the lower right corner. The sample code utilizes many of the functions, and data structures listed above. In the sample code, the surface, overlay, and underlay sizing are set up such that the surfaces, overlays, and underlays are smaller in size than the window surface. This is deliberately done in order to avoid excessive average depth complexity of the resulting graphics frame. Prior to executing the sample, EGL initialization should occur, which includes creating an EGL display.

```
3D_window = eglCreateWindowSurface( dpy, config, window, NULL );
// Now resize it to QVGA (src & dst rects)
// This will save buffer memory and 3D render time
EGLSurfaceScaleRect src_rect = {0, 0, 320, 240};
EGLSurfaceScaleRect dst_rect = {0, 0, 320, 240};
eglSetSurfaceScaleQUALCOMM ( dpy, 3D_window, &src_rect,
&dst_rect );
eglSurfaceScaleEnableQUALCOMM ( dpy, 3D_window, EGL_TRUE );
// Setup OpenGL ES rendering to only the QVGA region used
glViewport( 0, 0, 320, 240 );
glScissor( 0, 0, 320, 240 );
// Create a pbuffer for the skybox underlay
// Assume 3D content will always occlude lower half of QVGA window
// So we only need to update the upper half of the underlay
EGLint attribs[ ] = {EGL_WIDTH, 320, EGL_HEIGHT,
120, EGL_NONE};
skybox = eglCreatePbufferSurface( dpy, config, attribs);
// Position the skybox in the QVGA src rect of the composite surface
// 1 to 1 scaling (i.e. blit)
src_rect.height = 120;
dst_rect.y = 120;
dst_rect.height = 120;
eglSetSurfaceScaleQUALCOMM ( dpy, skybox, &src_rect, &dst_rect );
eglSurfaceScaleEnableQUALCOMM ( dpy, skybox, EGL_TRUE );
// Render the initial skybox
// Can use a single textured tri-strip or drawtexture for this
// Can disable depth/lighting etc for max performance
// Create a pbuffer for the tach dial overlay
attribs[1] = 40;
attribs[3] = 30;
dial = eglCreatePbufferSurface( dpy, config, attribs);
// Position the dial in the QVGA src rect of the composite surface
// 1 to 1 scaling (i.e. blit)
src_rect.width = 40;
src_rect.height = 30;
dst_rect.y = 0;
dst_rect.width = 40;
dst_rect.height = 30;
eglSetSurfaceScaleQUALCOMM ( dpy, dial, &src_rect, &dst_rect );
eglSurfaceScaleEnableQUALCOMM ( dpy, dial, EGL_TRUE );
// Can use eglSurfaceTransparency here to make the tach dial
// partially translucent
// Render the tachometer dial - this will remain static
// Create a pbuffer for the tach needle overlay
needle = eglCreatePbufferSurface( dpy, config, attribs);
// Position the needle in the QVGA src rect of the composite surface
// 1 to 1 scaling (i.e. blit)
// this directly overlays the dial... but since the dial is bound
// first, it will be combined first
eglSetSurfaceScaleQUALCOMM ( dpy, needle, &src_rect, &dst_rect );
eglSurfaceScaleEnableQUALCOMM ( dpy, needle, EGL_TRUE );
// Setup the color_key for the needle so the dial will show through
// use Magenta (0xFF00FF on 8-bit/comp devices)
// This assumes the setup code created a 565 window surface
eglSetSurfaceColorKeyQUALCOMM ( dpy, needle,  (0xFF >> 3), 0,
                        (0xFF >> 3)  );
eglSurfaceColorKeyEnableQUALCOMM ( dpy, needle, EGL_TRUE );
// Render the initial needle
// this will get updated once per frame or so
// don't update if the RPM change is small
// Be sure to set magenta as the clear color
// Create a pbuffer for the digital speedometer & gear overlay
attribs[1] = 80;
attribs[3] = 20;
speedo = eglCreatePbufferSurface( dpy, config, attribs);
// Position the speedometer in the QVGA src rect of the composite
surface
// 1 to 1 scaling (i.e. blit)
src_rect.width = 80;
src_rect.height = 20;
dst_rect.x = 240;
dst_rect.width = 80;
dst_rect.height = 20;
eglSetSurfaceScaleQUALCOMM ( dpy, speedo, &src_rect, &dst_rect );
eglSurfaceScaleEnableQUALCOMM ( dpy, speedo, EGL_TRUE );
// Setup the color_key for the speedo so the 3D surface
// will show through
// use Magenta (0xFF00FF on 8-bit/comp devices)
// This assumes the setup code created a 565 window surface
eglSetSurfaceColorKeyQUALCOMM ( dpy, speedo,  (0xFF >> 3),  0,
                        (0xFF >> 3)  );
eglSurfaceColorKeyEnableQUALCOMM ( dpy, speedo, EGL_TRUE );
// Render the initial speedometer and gear indicators
// this will get updated once per frame or so
// don't update if the speedometer change is small
// Create the “composite” surface
comp = eglCreateCompositeSurfaceQUALCOMM ( dpy, 3D_window, 0);
// Setup the “composite” surface to scale from QVGA to VGA
src_rect.width = 320;
src_rect.height = 240;
dst_rect.x = 0;
dst_rect.width = 640;
dst_rect.height = 480;
eglSetSurfaceScaleQUALCOMM ( dpy, comp, &src_rect, &dst_rect );
eglSurfaceScaleEnableQUALCOMM ( dpy, comp, EGL_TRUE );
// Bind the pbuffers to the overlay and underlay layers
eglSurfaceOverlayBindQUALCOMM ( dpy, comp, skybox, −1,
EGL_TRUE);
eglSurfaceOverlayBindQUALCOMM ( dpy, comp, dial, 1, EGL_TRUE);
eglSurfaceOverlayBindQUALCOMM ( dpy, comp, needle, 1,
EGL_TRUE);
eglSurfaceOverlayBindQUALCOMM ( dpy, comp, speedo, 1,
EGL_TRUE);
// Enable the layer combining...
eglSurfaceOverlayLayerEnableQUALCOMM ( dpy, comp, −1,
EGL_TRUE );
eglSurfaceOverlayLayerEnableQUALCOMM ( dpy, comp, 1,
EGL_TRUE );
eglSurfaceOverlayEnableQUALCOMM ( dpy, comp, EGL_TRUE );
// Any additional EGL setup ...
// Setup OpenGL ES rendering for the main 3D window surface
// Draw calls here
// Swap to the display, the enabled layers will be combined
// as they are copied to the associated native window
eglSwapBuffers( dpy, 3D_window, 3D_window, ctx );
```

In the sample code above, an EGL window surface is created, which initially has a width of 640 pixels and a height of 480 pixels. In this example, the dimensions of the window surface match the dimensions of the target display VGA display. Then, the window surface is resized to the dimensions of a QVGA (320×240) display in order to save buffer memory as well as 3D render time. The resizing takes place by setting up a source rectangle (i.e., src_rect) and a destination rectangle (i.e., dst rect). The source rectangle specifies or selects a portion of the EGL window surface that will be rescaled into the resulting surface. The destination rectangle specifies the final dimensions to which the portion of the EGL window surface specified by the source rectangle will be re-scaled. Since the surface is a window surface and the src_rect is smaller than the initial window size, the buffers associated with the window surface are shrunk to match the new surface dimensions, thus saving significant memory space and rendering bandwidth. After setting up these variables, the eglSetSurfaceScaleQUALCOMM function and the eglsurfacescaleEnableQUALCOMM function are called to resize the window surface according to the source and destination rectangles.

Then, several pbuffer surfaces are created, resized, and positioned for each of the various overlays and underlays described above. First, a pbuffer surface is created to depict a skybox underlay surface. The skybox underlay has a height of 120 pixels, which is half the height of the QVGA composite surface area, and may be positioned in the upper half of the composite surface area by calling the eglSetSurfaceScaleQUAL COMM and the eglSurfaceScaleEnableQUALCOMM functions. Because the skybox is only visible on the upper half of the composite surface area, extraneous rendering will be avoided by constraining the pbuffer surface to the upper half of the composite surface area. As a result, hardware throughput is improved. After the creation of the skybox underlay, two pbuffer overlay surfaces depicting a tachometer dial and needle are created and then positioned by calling the eglSetSurfaceScaleQUALCOMM function and the eglsurfacescaleEnableQUALCOMM function. Then a color key is set up for the needle overlay surface by calling the eglSetSurfaceColorKeyQUALCOMM function and the eglSurfaceColorKeyEnableQUALCOMM function. When a color-keyed surface is rendered to the display, any pixel which matches the specified transparency color (i.e., magenta) will not be copied to the display. This prevents background information contained in the needle overlay surface from obscuring the tachometer dial. Then, a pbuffer surface overlay depicting a digital speedometer and gear indicator is also created and positioned. A color key is also applied to the digital speedometer and gear indicator.

Next, a composite surface is created for the 3D_window window surface. The composite surface is set up to scale the combined surfaces from QVGA dimensions to the dimensions of the target display, which is VGA. Then, the different pbuffer surfaces are bound or attached to the composite surface by making several calls to the eglSurfaceoverlayBindQUALCOMM function. The skybox underlay layer is bound to layer having a level of “−1” and the other overlay surfaces corresponding to the tachometer dial, tachometer needle, digital speedometer, and gear indicator are all bound to layer having a level “1”. Again, the negative layer levels indicate underlay layers, and the positive layer levels indicate overlay layers. Then, each of the underlay and overlay layers (i.e., “−1” and “1”) within the overlay stack are enabled by calling the eglSurfaceOverlayLayerEnableQUALCOMM function. After enabling the individual layers, the overlay stack itself is enabled by calling the eglSurfaceOverlayEnableQUALCOMM function.

After completing the OpenGL ES rendering to the 3D window surface, the sample code calls a modified eglSwapBuffers function. The window surface associated with the overlay stack (i.e., 3D_window) is passed as a parameter to the function. In one aspect, the modified eglswapbuffers function may combine the surfaces and layers according to the overlay stack, sizing information, color-keying information, and binding information provided by the sample code. After combining the surfaces and layers, the eglSwapBuffers function may copy the resulting graphics frame into the associated native window (i.e., dpy).

In another aspect, the modified eglswapbuffers function may send instructions to display processor 114 in order to combine the surfaces and layers. In response to the instructions, display processor 114 may then perform various surface combination functions, such as the compositing algorithms described in this disclosure, which may include overwriting, color keying with constant alpha blending, color keying without constant alpha blending, full surface constant alpha blending, or full surface per-pixel alpha blending. For each surface, the eglSwapbuffers function may perform complex calculations and set up various data structures that are used by display processor 114 when combining the surfaces. In order to prepare this data, eglswapbuffers may traverse the overlay stack beginning with the layer that has the lowest level and proceeding in order up to base layer, which contains the window surface. Within each layer, the function may proceed through each surface in the order in which it was bound to the layer. Then, the function may process the base layer (i.e., layer 0) containing the window surface, and in some cases, other surfaces. Finally, the function will proceed to process the overlay layers, starting with layer level 1 and proceeding in order up to the highest layer, which appears closest to the viewer of the display. In this manner, eglSwapBuffers systematically processes each surface in order to prepare data for display processor 114 to use.

The apparatuses, methods, and computer program products described above may be employed various types of devices, such as a wireless phone, a cellular phone, a laptop computer, a wireless multimedia device (e.g., a portable video player or portable video gaming device), a wireless communication personal computer (PC) card, a personal digital assistant (PDA), an external or internal modem, or any device that communicates through a wireless channel.

Such devices may have various names, such as access terminal (AT), access unit, subscriber unit, mobile station, mobile device, mobile unit, mobile phone, mobile, remote station, remote terminal, remote unit, user device, user equipment, handheld device, etc.

The techniques described in this disclosure may be implemented within a general purpose microprocessor, digital signal processor (DSP), application specific integrated circuit (ASIC), field programmable gate array (FPGA), or other equivalent logic devices. Accordingly, the terms “processor” or “controller,” as used herein, may refer to one or more of the foregoing structures or any combination thereof, as well as to any other structure suitable for implementation of the techniques described herein. Moreover, the terms “processor” or “controller” may also refer to one or more processors or one or more controllers that perform the techniques described herein.

The components and techniques described herein may be implemented in hardware, software, firmware, or any combination thereof. Any features described as modules or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-media applications and devices. In some aspects, for example, such components may form part of a mobile device, such as a wireless communication device handset.

If implemented in software, the techniques may be realized at least in part by a computer-readable medium comprising instructions that, when executed by one or more processors, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), FLASH memory, magnetic or optical data storage media.

The techniques additionally, or alternatively, may be realized at least in part by a computer-readable communication medium that carries or communicates code in the form of instructions or data structures and that can be accessed, read, and/or executed by one or more processors. Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Any software that is utilized may be executed by one or more processors, such as one or more DSP's, general purpose microprocessors, ASIC's, FPGA's, or other equivalent integrated or discrete logic circuitry.

Various aspects of the disclosure have been described. These and other aspects are within the scope of the following claims.

1. A device comprising:
a first processor that selects a surface level for each of a plurality of rendered graphics surfaces prior to the device outputting any of the rendered graphics surfaces to a display; and
a second processor that retrieves the rendered graphics surfaces, overlays the rendered graphics surfaces onto a graphics frame in accordance with each of the selected surface levels, and outputs the graphics frame to the display.

2. The device of claim 1, wherein:
the first processor and the second processor are separate processors, and
the first processor and the second processor are each selected from a group consisting of a graphics processor, a display processor, and a control processor.

3. The device of claim 1, further comprising:
one or more surface buffers; and
a third processor that renders the rendered graphics surfaces, and stores the rendered graphics surfaces in the one or more surface buffers,
wherein the second processor retrieves the rendered graphics surfaces from the one or more surface buffers.

4. The device of claim 3, wherein:
the third processor comprises a graphics processor comprising an accelerated three-dimensional (3D) graphics pipeline, and
the first processor comprises a control processor comprising a general purpose processing pipeline.

5. The device of claim 3, wherein:
the rendered graphics surfaces comprise a first set of rendered graphics surfaces,
the first processor renders a second set of rendered graphics surfaces, and selects a surface level for each of the rendered graphics surfaces in the second set of rendered graphics surfaces prior to the device outputting any of the rendered graphics surfaces to the display, and
the second processor overlays the second set of rendered graphics surfaces onto the graphics frame in accordance with the selected surface levels.

6. The device of claim 5, wherein:
at least one of the rendered graphics surfaces in the first set of rendered graphics surfaces comprises an on-screen surface, and
each of the rendered graphics surfaces in the second set of rendered graphics surfaces comprises an off-screen surface.

7. The device of claim 5, wherein:
each of the rendered graphics surfaces in the first set of rendered graphics surfaces comprises a three-dimensional (3D) surface, and
at least one of the rendered graphics surfaces in the second set of rendered graphics surfaces comprises a surface selected from a group consisting of a two-dimensional (2D) surface and a video surface.

8. The device of claim 3, wherein:
the third processor comprises a primitive processing unit that performs operations on primitives, and a pixel processing unit that performs pixel operations, and
the second processor performs a limited set of the pixel operations.

9. The device of claim 8, wherein a number of unique pixel operations performed by the second processor is less than a number of unique pixel operations performed by the pixel processing unit.

10. The device of claim 1, wherein:
the second processor comprises an overwrite block, and
when the rendered graphics surfaces overlap, the overwrite block selects one of the rendered graphics surfaces having a highest surface level, and formats the graphics frame such that the selected one of the rendered graphics surfaces is displayed for overlapping portions of the rendered graphics surfaces.

11. The device of claim 1, wherein:
the second processor overlays the rendered graphics surfaces onto the graphics frame at least in part by combining the rendered graphics surfaces according to one or more compositing modes, wherein the one or more compositing modes include at least one of color keying with constant alpha blending, color keying without constant alpha blending, full surface constant alpha blending, or full surface per-pixel alpha blending.

12. The device of claim 1, wherein:
the first processor generates an overlay stack having a plurality of layers, and binds each of the rendered graphics surfaces to individual layers within the overlay stack,
the second processor overlays the rendered graphics surfaces onto the graphics frame in accordance with the overlay stack.

13. The device of claim 12, wherein:
each of the layers in the overlay stack has a unique layer level, and
when the graphics frame is displayed on the display, rendered graphics surfaces bound to a layer having a first layer level within the overlay stack appear closer to a viewer of the display than rendered graphics surfaces bound to layers having layer levels lower than the first layer level.

14. The device of claim 12, wherein:
the first processor selectively enables and disables individual layers within the overlay stack for each graphics frame to be displayed,
when a first layer within the overlay stack is enabled for a first graphics frame, the second processor processes each of the rendered graphics surfaces bound to the first layer to generate the first graphics frame, and
when the first layer is disabled for the first graphics frame, the second processor does not process any rendered graphics surfaces bound to the first layer to generate the first graphics frame.

15. The device of claim 1, wherein:
the first processor selectively enables and disables individual rendered graphics surfaces for each graphics frame to be displayed;
when a first rendered graphics surface within the plurality of rendered graphics surfaces is enabled for a first graphics frame, the second processor processes the first rendered graphics surface to generate the first graphics frame;
when the first rendered graphics surface is disabled for the first graphics frame, the second processor does not process the first rendered graphics surface to generate the first graphics frame.

16. The device of claim 1, wherein the rendered graphics surfaces comprise a first set of rendered graphics surfaces, the device further comprising:
a first surface buffer;
a second surface buffer;
a first graphics processor that generates the first set of rendered graphics surfaces, and stores the first set of rendered graphics surfaces in the first surface buffer; and
a second graphics processor that generates a second set of rendered graphics surfaces, and stores the second set of rendered graphics surfaces in the second surface buffer,
wherein the first processor selects a surface level for each of the rendered graphics surfaces within the second set of rendered graphics surfaces prior to the device outputting any of the rendered graphics surfaces to the display, and
wherein the second processor retrieves the first set of rendered graphics surfaces from the first surface buffer, retrieves the second set of rendered graphics surfaces from the second surface buffer, and overlays the first set of rendered graphics surfaces and the second set of rendered graphics surfaces onto the graphics frame in accordance with each of the selected surface levels.

17. The device of claim 16, wherein:
the first graphics processor comprises an accelerated three-dimensional (3D) graphics pipeline; and
the second graphics processor comprises an accelerated two-dimensional (2D) graphics pipeline.

18. The device of claim 1, wherein the device comprises a wireless communication device handset.

19. The device of claim 1, wherein the device comprises one or more integrated circuit devices.

20. A method comprising:
retrieving a plurality of rendered graphics surfaces;
selecting a surface level for each of the rendered graphics surfaces prior to outputting any of the rendered graphics surfaces to a display;
overlaying the rendered graphics surfaces onto a graphics frame in accordance with each of the selected surface levels; and
outputting the graphics frame to the display.

21. The method of claim 20, further comprising:
generating the rendered graphics surfaces; and
storing the rendered graphics surfaces in one or more surface buffers,
wherein retrieving the plurality of rendered graphics surfaces comprises retrieving the plurality of rendered graphics surfaces from the one or more surface buffers.

22. The method of claim 20, wherein the rendered graphics surfaces comprise a first set of rendered graphics surfaces, and wherein the method further comprises:
generating the first set of rendered graphics surfaces with a first processor;
generating a second set of rendered graphics surfaces with a second processor, wherein the first processor and the second processor are separate processors;
selecting a surface level for each rendered graphics surface in the second set of rendered graphics surfaces; and
overlaying the second set of rendered graphics surfaces onto the graphics frame in accordance with the selected surface levels.

23. The method of claim 22, wherein:
at least one of the rendered graphics surfaces in the first set of rendered graphics surfaces comprises an on-screen surface, and
each of the rendered graphics surfaces in the second set of rendered graphics surfaces comprises an off-screen surface.

24. The method of claim 22, wherein:
each of the rendered graphics surfaces in the first set of rendered graphics surfaces comprises a three-dimensional (3D) surface, and
at least one of the rendered graphics surfaces in the second set of rendered graphics surfaces comprises a surface selected from a group consisting of a two-dimensional (2D) surface and a video surface.

25. The method of claim 20, wherein overlaying the rendered graphics surfaces onto the graphics frame in accordance with each of the selected surface levels comprises:
selecting one of the rendered graphics surfaces having a highest surface level when the rendered graphics surfaces overlap; and
formatting the graphics frame such that the selected one of the rendered graphics surfaces is displayed for overlapping portions of the rendered graphics surfaces.

26. The method of claim 20, wherein overlaying the rendered graphics surfaces onto the graphics frame in accordance with each of the selected surface levels comprises:
combining the rendered graphics surfaces according to one or more compositing modes, wherein the one or more compositing modes include at least one of color keying with constant alpha blending, color keying without constant alpha blending, full surface constant alpha blending, or full surface per-pixel alpha blending.

27. The method of claim 20, further comprising:
generating an overlay stack having a plurality of layers;
binding each of the rendered graphics surfaces to individual layers within the overlay stack;
overlaying the rendered graphics surfaces onto the graphics frame in accordance with the overlay stack.

28. The method of claim 27, wherein each of the layers in the overlay stack has a unique layer level, and wherein overlaying the rendered graphics surfaces onto the graphics frame in accordance with the overlay stack comprises:
formatting the graphics frame such that when the graphics frame is displayed on the display, rendered graphics surfaces bound to a layer having a first layer level within the overlay stack appear closer to a viewer of the display than rendered graphics surfaces bound to layers having layer levels lower than the first layer level.

29. The method of claim 27, further comprising:
selectively enabling individual layers within the overlay stack for each graphics frame to be displayed;
processing each of the rendered graphics surfaces bound to a first layer within the overlay stack to generate a first graphics frame when the first layer is enabled for the first graphics frame; and
not processing any rendered graphics surfaces bound to the first layer to generate the first graphics frame when the first layer is disabled for the first graphics frame.

30. The method of claim 27, further comprising:
selectively enabling individual rendered graphics surfaces for each graphics frame to be displayed;
processing a first rendered graphics surface to generate a first graphics frame when a first rendered graphics surface is enabled for a first graphics frame;
not processing the first rendered graphics surface to generate the first graphics frame when the first rendered graphics surface is disabled for the first graphics frame.

31. The method of claim 20, wherein the rendered graphics surfaces comprise a first set of rendered graphics surfaces, and wherein the method further comprises:
generating the first set of rendered graphics surfaces with a first graphics processor;
generating a second set of rendered graphics surfaces with a second graphics processor;
storing the first set of rendered graphics surfaces in a first surface buffer;
storing the second set of rendered graphics surfaces in a second surface buffer;
selecting a surface level for each rendered graphics surfaces within the second set of rendered graphics surfaces prior to outputting any of the rendered graphics surfaces to the display;
retrieving the first set of rendered graphics surfaces from the first surface buffer;
retrieving the second set of rendered graphics surfaces from the second surface buffer; and
overlaying the first set of rendered graphics surfaces and the second set of rendered graphics surfaces onto the graphics frame in accordance with each of the selected surface levels.

32. The method of claim 31, wherein:
the first graphics processor comprises an accelerated three-dimensional (3D) graphics pipeline; and
the second graphics processor comprises an accelerated two-dimensional (2D) graphics pipeline.

33. A device comprising:
means for retrieving a plurality of rendered graphics surfaces;
means for selecting a surface level for each of the rendered graphics surfaces prior to outputting any of the rendered graphics surfaces to a display;
means for overlaying the rendered graphics surfaces onto a graphics frame in accordance with each of the selected surface levels; and
means for outputting the graphics frame to the display.

34. The device of claim 33, further comprising:
means for generating the rendered graphics surfaces; and
means for storing the rendered graphics surfaces in one or more surface buffers,
wherein the means for retrieving the plurality of rendered graphics surfaces comprises means for retrieving the plurality of rendered graphics surfaces from the one or more surface buffers.

35. The device of claim 33, wherein the rendered graphics surfaces comprise a first set of rendered graphics surfaces, and wherein the device further comprises:
means for generating the first set of rendered graphics surfaces with a first processor;
means for generating a second set of rendered graphics surfaces with a second processor, wherein the first processor and the second processor are separate processors;
means for selecting a surface level for each rendered graphics surface in the second set of rendered graphics surfaces; and
means for overlaying the second set of rendered graphics surfaces onto the graphics frame in accordance with the selected surface levels.

36. The device of claim 35, wherein:
at least one of the rendered graphics surfaces in the first set of rendered graphics surfaces comprises an on-screen surface, and
each of the rendered graphics surfaces in the second set of rendered graphics surfaces comprises an off-screen surface.

37. The device of claim 35, wherein:
each of the rendered graphics surfaces in the first set of rendered graphics surfaces comprises a three-dimensional (3D) surface, and
at least one of the rendered graphics surfaces in the second set of rendered graphics surfaces comprises a surface selected from a group consisting of a two-dimensional (2D) surface and a video surface.

38. The device of claim 33, wherein the means for overlaying the rendered graphics surfaces onto the graphics frame in accordance with each of the selected surface levels comprises:
means for selecting one of the rendered graphics surfaces having a highest surface level when the rendered graphics surfaces overlap; and
means for formatting the graphics frame such that the selected one of the rendered graphics surfaces is displayed for overlapping portions of the rendered graphics surfaces.

39. The device of claim 33, wherein the means for overlaying the rendered graphics surfaces onto the graphics frame in accordance with each of the selected surface levels comprises:
means for combining the rendered graphics surfaces according to one or more compositing modes, wherein the one or more compositing modes include at least one of color keying with constant alpha blending, color keying without constant alpha blending, full surface constant alpha blending, or full surface per-pixel alpha blending.

40. The device of claim 33, further comprising:
means for generating an overlay stack having a plurality of layers;
means for binding each of the rendered graphics surfaces to individual layers within the overlay stack and
means for overlaying the rendered graphics surfaces onto the graphics frame in accordance with the overlay stack.

41. The device of claim 40, wherein each of the layers in the overlay stack has a unique layer level, and wherein the means for overlaying the rendered graphics surfaces onto the graphics frame in accordance with the overlay stack comprises:
means for formatting the graphics frame such that when the graphics frame is displayed on the display, rendered graphics surfaces bound to a layer having a first layer level within the overlay stack appear closer to a viewer of the display than rendered graphics surfaces bound to layers having layer levels lower than the first layer level.

42. The device of claim 40, further comprising:
means for selectively enabling individual layers within the overlay stack for each graphics frame to be displayed; and
means for processing each of the rendered graphics surfaces bound to a first layer within the overlay stack to generate a first graphics frame when the first layer is enabled for the first graphics frame, and not processing any rendered graphics surfaces bound to the first layer to generate the first graphics frame when the first layer is disabled for the first graphics frame.

43. The device of claim 33, further comprising:
means for selectively enabling individual rendered graphics surfaces for each graphics frame to be displayed; and
means for processing a first rendered graphics surface to generate a first graphics frame when a first rendered graphics surface is enabled for a first graphics frame, and not processing the first rendered graphics surface to generate the first graphics frame when the first rendered graphics surface is disabled for the first graphics frame.

44. The device of claim 33, wherein the rendered graphics surfaces comprise a first set of rendered graphics surfaces, and wherein the device further comprises:
means for generating the first set of rendered graphics surfaces with a first graphics processor;
means for generating a second set of rendered graphics surfaces with a second graphics processor;
means for storing the first set of rendered graphics surfaces in a first surface buffer;
means for storing the second set of rendered graphics surfaces in a second surface buffer;
means for selecting a surface level for each rendered graphics surface within the second set of rendered graphics surfaces prior to the device outputting any of the rendered graphics surfaces to the display;
means for retrieving the first set of rendered graphics surfaces from the first surface buffer;
means for retrieving the second set of rendered graphics surfaces from the second surface buffer; and
means for overlaying the first set of rendered graphics surfaces and the second set of rendered graphics surfaces onto the graphics frame in accordance with each of the selected surface levels.

45. The device of claim 44, wherein:
the first graphics processor comprises an accelerated three-dimensional (3D) graphics pipeline; and
the second graphics processor comprises an accelerated two-dimensional (2D) graphics pipeline.

46. A computer-readable medium comprising instructions that cause one or more processors to:
retrieve a plurality of rendered graphics surfaces;
select a surface level for each of the rendered graphics surfaces prior to outputting any of the rendered graphics surfaces to a display;
overlay the rendered graphics surfaces onto a graphics frame in accordance with each of the selected surface levels; and
output the graphics frame to the display.

47. The computer-readable medium of claim 46, further comprising instructions that cause the one or more processors to:
generate the rendered graphics surfaces; and
store the rendered graphics surfaces in one or more surface buffers,
wherein the instructions that cause the one or more processors to retrieve the plurality of rendered graphics surfaces comprise instructions that cause the one or more processors to retrieve the plurality of rendered graphics surfaces from the one or more surface buffers.

48. The computer-readable medium of claim 46, wherein the rendered graphics surfaces comprise a first set of rendered graphics surfaces, and wherein the computer-readable medium further comprises instructions that cause the one or more processors to:
generate the first set of rendered graphics surfaces;
generate a second set of rendered graphics surfaces;
select a surface level for each rendered graphics surface in the second set of rendered graphics surfaces; and
overlay the first set of rendered graphics surfaces and the second set of rendered graphics surfaces onto the graphics frame in accordance with the selected surface levels.

49. The computer-readable medium of claim 48, wherein:
at least one of the rendered graphics surfaces in the first set of rendered graphics surfaces comprises an on-screen surface, and
each of the rendered graphics surfaces in the second set of rendered graphics surfaces comprises an off-screen surface.

50. The computer-readable medium of claim 48, wherein:
each of the rendered graphics surfaces in the first set of rendered graphics surfaces comprises a three-dimensional (3D) surface, and
at least one of the rendered graphics surfaces in the second set of rendered graphics surfaces comprises a surface selected from a group consisting of a two-dimensional (2D) surface and a video surface.

51. The computer-readable medium of claim 46, wherein the instructions that cause the one or more processors to overlay the rendered graphics surfaces onto the graphics frame in accordance with each of the selected surface levels comprise instructions that cause the one or more processors to:
select one of the rendered graphics surfaces having a highest surface level when the rendered graphics surfaces overlap; and
format the graphics frame such that the selected one of the rendered graphics surfaces is displayed for overlapping portions of the rendered graphics surfaces.

52. The computer-readable medium of claim 46, wherein the instructions that cause the one or more processors to overlay the rendered graphics surfaces onto the graphics frame in accordance with each of the selected surface levels comprise instructions that cause the one or more processors to:
combine the rendered graphics surfaces according to one or more compositing modes, wherein the one or more compositing modes include at least one of color keying with constant alpha blending, color keying without constant alpha blending, full surface constant alpha blending, or full surface per-pixel alpha blending.

53. The computer-readable medium of claim 46, further comprising instructions that cause the one or more processors to:
generate an overlay stack having a plurality of layers;
bind each of the rendered graphics surfaces to individual layers within the overlay stack; and
overlay the rendered graphics surfaces onto the graphics frame in accordance with the overlay stack.

54. The computer-readable medium of claim 53, wherein each of the layers in the overlay stack has a unique layer level, and wherein the instructions that cause the one or more processors to overlay the rendered graphics surfaces onto the graphics frame in accordance with the overlay stack comprise instructions that cause the one or more processors to:
format the graphics frame such that when the graphics frame is displayed on the display, rendered graphics surfaces bound to a layer having a first layer level within the overlay stack appear closer to a viewer of the display than rendered graphics surfaces bound to layers having layer levels lower than the first layer level.

55. The computer-readable medium of claim 53, further comprising instructions that cause the one or more processors to:
selectively enable individual layers within the overlay stack for each graphics frame to be displayed;
process each of the rendered graphics surfaces bound to a first layer within the overlay stack to generate a first graphics frame when the first layer is enabled for the first graphics frame; and
not process any rendered graphics surfaces bound to the first layer to generate the first graphics frame when the first layer is disabled for the first graphics frame.

56. The computer-readable medium of claim 46, further comprising instructions that cause the one or more processors to:
selectively enable individual rendered graphics surfaces for each graphics frame to be displayed;
process a first rendered graphics surface to generate a first graphics frame when a first rendered graphics surface is enabled for a first graphics frame; and
not process the first rendered graphics surface to generate the first graphics frame when the first rendered graphics surface is disabled for the first graphics frame.

57. The computer-readable medium of claim 46, wherein the rendered graphics surfaces comprise a first set of rendered graphics surfaces, and wherein the computer-readable medium further comprises instructions that cause the one or more processors to:
generate the first set of rendered graphics surfaces with a first graphics processor;
generate a second set of rendered graphics surfaces with a second graphics processor;
store the first set of rendered graphics surfaces in a first surface buffer;
store the second set of rendered graphics surfaces in a second surface buffer;
select a surface level for each rendered graphics surfaces within the second set of rendered graphics surfaces prior to the device outputting any of the rendered graphics surfaces to the display;
retrieve the first set of rendered graphics surfaces from the first surface buffer;
retrieve the second set of rendered graphics surfaces from the second surface buffer; and
overlay the first set of rendered graphics surfaces and the second set of rendered graphics surfaces onto the graphics frame in accordance with each of the selected surface levels.

58. The computer-readable medium of claim 57, wherein:
the first graphics processor comprises an accelerated three-dimensional (3D) graphics pipeline; and
the second graphics processor comprises an accelerated two-dimensional (2D) graphics pipeline.
